(19) United States
(12) Patent Application Publication
(10) Pub. No.: US 2026/0140342 A1
(43) Pub. Date: May 21, 2026

(54) OPTICAL CONNECTIVITY SOLUTION FOR FIBER TO HOME NETWORK

(71) Applicant: STERLITE TECHNOLOGIES LIMITED, Gurugram (IN)

(72) Inventors: Eric Emmanual Alston, Lugoff, SC (US); Sunil Kumar, Gurugram (IN); Mohammad Rafique Shah, Gurugram (IN)

(21) Appl. No.: 19/393,357

(22) Filed: Nov. 18, 2025

(30) Foreign Application Priority Data
Nov. 19, 2024 (IN) 202411089581

(51) Int. Cl. G02B 6/44

(52) U.S. Cl. CPC G02B 6/4446; G02B 6/4444

(57) ABSTRACT

The present disclosure relates to a fiber enclosure (300) for receiving and managing a plurality of optical fibers including a housing defining an interior volume, a plurality of input ports (308) provided on at least one of the sidewalls (304), a plurality of fanout units (310, 312) disposed within the housing, a multi-tiered adapter frame (402) comprising a stair arrangement removably mounted within the interior volume of the housing and and a plurality of optical fiber adapters (404). Further the multi-tiered adapter frame (402) includes a plurality of horizontally-extending step portions (412) separated by vertically-extending riser portions (430). Each of the horizontally-extending step portions (412) lie in a horizontal plane vertically offset from adjacent horizontally-extending step portions (412).

### CROSS-REFERENCE TO RELATED APPLICATIONS

The present application claims the benefit of Indian Application No. IN202411089581 titled “OPTICAL CONNECTIVITY SOLUTION FOR FIBER TO HOME NETWORK” filed by the applicant on 19 Nov. 2024 which is incorporated herein by reference in its entirety.

### FIELD OF THE INVENTION

Embodiments of the present invention relate to the field of wireless communication networks of optical fibres and optical fiber cable management, and in particular, relates to a fiber enclosure specifically configured for the reception and management of a plurality of optical fibers.

### DESCRIPTION OF THE RELATED ART

Optical fiber refers to the technology and the medium for the transmission of data as light pulses along an ultrapure strand of glass, which is as thin as a human hair. For many years, optical fibers have been extensively used in high-performance and long-distance data and networking. Modern optical devices and optical communications systems widely use fiber optic cables. Fiber optic cables are often used to transmit light signals for high speed data transmission.

Optical fiber cables utilize optical fibers to transmit signals such as voice, video, image, data or information. Optical fibers are strands of glass fiber processed so that light beams transmitted through the glass fiber are subject to total internal reflection wherein a large fraction of the incident intensity of light directed into the fiber is received at the other end of the fiber.

Optical fiber cables are essential components in fiber-to-home (FTTH) networks, enabling high-speed data transmission to residential users. Various methods and systems have been developed for distributing and managing these optical fiber cables within FTTH networks.

In recent years, each large fixed network operator all announces to come into effect the development tactics of “light entering and copper back”, shorten the copper cable length in network, optical fiber is further extended to user, by building optical fiber (Fiber To Thex somewhither, referred to as FTTx) engineering progressively use optical cable to substitute the main section in traditional copper cable Access Network, feeder line section, divide line segment, with the line segment of registering one's residence, by take at present traditional Access Network that copper cable is main transmission medium, be evolved to and take the broadband optical access net that optical fiber is main transmission medium, finally can realize fiber-to-the-home front yard (Fiber To The Home for user, referred to as FTTH).

In “light entering and copper back” implementation of strategies process, EPON (Passive Optical Network, referred to as PON) technology is considered to build the topmost broadband access technology of FTTx, this makes such as Ethernet passive optical network (Ethernet Passive Optical Network, referred to as EPON) and the broadband PON technology of gigabit passive optical network (Gigabit-Capable Passive Optical Network, referred to as GPON) be subject to the extensive concern of each operator.

Current demand requires fiber enclosures that can manage extreme high-density applications, driven by exploding bandwidth needs and end-user proliferation. This creates a conflict: either the enclosure scales dramatically in size to preserve port accessibility and bend radius—rendering it impractical for space-constrained deployments (e.g., wall-mount, pole-mount, or underground enclosures)—or it remains compact, but at the severe cost of port inaccessibility, fiber microbending, and signal degradation. Some prior art mentions stair-type structures which merely provide passive shelving for cassette placement with rear- or side-facing ports requiring extraction for access.

In light of the above stated discussion, there is a need for a fundamentally new design that eliminates cassettes, enforces bend radius structurally, and maximizes port density, while providing accessibility in a compact enclosure to overcomes the above stated shortcomings of traditionally available modules. Thus, the present invention proposes a technical solution that overcomes the above-stated limitations in the prior arts by providing a fiber enclosure specifically configured for the reception and management of a plurality of optical fibers.

### SUMMARY OF THE INVENTION

Embodiments of the present invention relates to a cassette-free, tiered-adapter fiber enclosure that resolves the high-density conflict through a three-dimensional arrangement of staggered, front-facing adapter blocks. In particular, each block enforces a 5 mm or 7.5 mm (or 5 mm) minimum bend radius and route IBR directly from breakout to mass-fusion-ready 250 μm pitch arrays—preserving intermittent bonds without disruption. Further, it may deliver higher port density versus conventional systems, may support 1:2 to 1:64 (preferably 1:4 to 1:32) feeder-to-distribution ratios in a single compact unit, and may eliminate splice trays entirely.

In accordance with an embodiment of the present invention, a fiber enclosure (300) for receiving and managing a plurality of optical fibers is characterized by a housing with a base (302), sidewalls (304), and cover (314); input ports (308) on at least one sidewall receiving input cables (202) containing optical fiber bundles made of fibers bendable to 7.5 mm (or preferably 5 mm) radius without substantial signal loss; fanout units (310, 312) inside the housing dividing each bundle into individual fibers; and a removably mounted multi-tiered adapter frame (402) forming a stair arrangement with horizontally-extending step portions (412) separated by vertically-extending riser portions (430), each step portion offset in plane from adjacent ones, and optical fiber adapters (404) mounted thereon such that all adapter ports (422a) face a common front access direction (A) at a mounting angle of 80°-110° relative to the step portion, with riser portions being angled (45°-135°) or curved (non-linear surface).

In accordance with an embodiment of the present invention, the fiber enclosure with multi-tiered adapter frames with vertically offset step portions (11.6-12.5 mm) and step depth (15-26.5 mm), enabling higher port density and front access using standard connectors without cassettes or trays.

In accordance with an embodiment of the present invention, the fiber enclosure has a single-piece integrated adapter block (8-12 sub-adapters, integrally molded) with snap-fit removable mounting on step portions, eliminating individual adapter alignment and enabling feeder/distribution segregation. In particular, the adapter ports are oriented in a common front access direction of 80° to 100° (preferably perpendicular) on staggered steps, ensuring unobstructed access and 7.5 mm (or 5 mm) bend radius for fibers. The plurality of horizontally-extending step portions (412) are curved (a non-linear surface) or angled between 45° and 135°. In an example, the vertically-extending riser portions (430) are 90° to the plurality of horizontally-extending step portions (412). In another example, the vertically-extending riser portions (430) are 80° to 100° to the plurality of horizontally-extending step portions (412). In another example, the vertically-extending riser portions (430) are 45° and 135° to the plurality of horizontally-extending step portions (412). In another example, the vertically-extending riser portions (430) can be concave, convex, sinusoidal, and so forth.

In accordance with an embodiment of the present invention, the fiber enclosure with IBR-preserving breakout assemblies with furcation tubes outputting bonded ribbon segments, enabling non-disruptive mass fusion at 250 μm pitch without bond damage.

Further, the fiber enclosure with optimized fiber lengths such that feeder paths are 260-470 mm, distribution paths are 260-280 mm, structurally enforced by fanout placement beneath the stair frame. Furthermore, the fiber enclosure has vertically stacked, pivotable splice holder plates for mass fusion splicing in a dedicated region, fully accessible without disassembly.

In accordance with an embodiment of the present invention, the fiber enclosure with wider end steps with mounting features and removable, vertically offset cable routing fingers on every step, enabling tool-free frame installation and segregated routing. Further, the fiber enclosure has a scalable 1:2 to 1:64 (preferably 1:4 to 1:32) feeder-to-distribution ratio in a single compact enclosure using mixed-density input ports and tier-specific adapter blocks.

In accordance with an embodiment of the present invention, the fiber enclosure having a housing with a base, sidewalls, and cover, input ports on at least one sidewall receiving input cables having optical fiber bundles with bendable to 5 mm or 7.5 mm (or 5 mm) radius without substantial signal loss; fanout units dividing each bundle into individual fibers; and a multi-tiered adapter frame defining a stair arrangement removably mounted within the housing. Further, the frame has horizontally-extending step portions separated by vertically-extending riser portions, each step in a plane offset from adjacent step portions, and optical fiber adapters mounted thereon such that all adapter ports face a common front access direction (A). Each adapter port is mounted at a perpendicular angle (45°-135°) relative to its step portion or on a curved surface, ensuring full front access and bend radius compliance.

In accordance with an embodiment of the present invention, the fiber enclosure with the stair arrangement defined by a vertical offset of 11.6 mm to 12.5 mm between adjacent step portions and a step depth of 15 mm to 26.5 mm, these ranges specifically configured to accommodate the mounting angles while maintaining 5 mm or 7.5 mm (or 5 mm) minimum bend radius (or 5 mm minimum bend radius) and unobstructed front access to every port.

In accordance with an embodiment of the present invention, the fiber enclosure supports mixed-density input cables, having at least one feeder cable and one higher-density distribution cable, with a fiber count ratio of 1:2 to 1:64 (preferably 1:4 to 1:32), enabling extreme scalability in a single compact unit. In particular, each optical fiber adapter is a single-piece integrated adapter block comprising 8 to 12 integrally molded sub-adapters, removably mounted directly on the step portions without secondary fixtures. Further, the mounted adapter blocks are designated as feeder adapter blocks and distribution adapter blocks, with the number of distribution blocks substantially exceeding feeder blocks to match high split ratios. Furthermore, each sub-adapter has a second port facing the base and a first port facing the cover; the multi-tiered frame providing vertical segregation of fiber routing paths from fanouts to second ports, preventing crossover and ensuring bend control.

In accordance with an embodiment of the present invention, at least two step portions—typically the first and last have greater width than others and include mounting features for removable attachment of the entire frame to the enclosure. The wider first or last step supports at least two adapter blocks, one being a feeder block.

In accordance with an embodiment of the present invention, the fiber enclosure where each step portion has attachment features to which cable routing fingers are removably attached, with fingers on adjacent steps vertically offset to create layered, non-overlapping routing channels. The input cables have Intermittently Bonded Ribbon (IBR) bundles (204) where optical fibers are bonded intermittently in a staggered pattern, preserving rollable deployment and mass fusion capability.

In accordance with an embodiment of the present invention, the fiber enclosure with Breakout assemblies coupled to input ports each include a housing with one input opening for an IBR bundle and multiple through holes outputting bond-preserved IBR segments in furcation tubes, enabling non-disruptive breakout without damaging intermittent bonds. Further, the fiber enclosure has a feeder fanout unit that is mounted on the base beneath the adapter frame; fiber paths from this unit to feeder adapter ports are constrained to 260 mm to 470 mm, ensuring slack control and bend compliance without excess.

In accordance with an embodiment of the present invention, the fiber enclosure with distribution fanout units that are mounted on the base beneath corresponding adapter blocks; fiber paths to distribution adapter ports are limited to 260 mm to 280 mm, optimizing routing density and bend safety.

In accordance with an embodiment of the present invention, where each distribution fanout unit has ribbonized fiber input at one end and individual fibers exiting through holes directly mated to distribution adapter second ports.

In accordance with an embodiment of the present invention, the fiber enclosure with a splicing region has pivotably connected splice holder plates stacked vertically. Further, each holding multiple mass fusion splice holders, allowing high-density splicing with full accessibility.

In accordance with an embodiment of the present invention, the adapter frame has a multi-tiered stair body with wider end steps. In particular, the adapters are mounted perpendicularly to step surfaces, and mounting features on wider steps for tool-free enclosure integration. Further, the frame receives single-piece integrated adapter blocks secured via snap-fit mechanisms on step portions.

In accordance with an embodiment of the present invention, snap-fit mounting enables rapid block installation and replacement without tools.

In accordance with an embodiment of the present invention, the wider first or last step accommodates at least two adapter blocks, including one feeder block, maximizing input capacity at frame extremities. Further, each step has attachment features for removable cable routing fingers, with vertical offset between fingers on adjacent steps, forming a 3D segregated routing lattice that enforces bend radius and prevents tangling.

The foregoing objectives of the present invention are attained by employing a fiber enclosure specifically configured for the reception and management of a plurality of optical fibers.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and a person of ordinary skill in the art can derive other implementations from these accompanying drawings without creative efforts. All of the embodiments or the implementations shall fall within the protection scope of the present invention.

FIG. 1 is a pictorial snapshot illustrating a front view of a fiber enclosure, in accordance with an aspect of the present invention.

FIG. 2 is a pictorial snapshot illustrating a side view of a fiber enclosure with multiple fiber management components, in accordance with an aspect of the present invention;

FIG. 3 is a pictorial snapshot illustrating a perspective view of one of the input cables in accordance with an aspect of the present invention;

FIG. 4 is a pictorial snapshot illustrating a detailed view of IBR bundle segments representing the structure of intermittently bonded ribbon optical fibers in accordance with an aspect of the present invention;

FIG. 5 is a pictorial snapshot illustrating a schematic view of an IBR bundle separation process within a breakout assembly in accordance with an aspect of the present invention;

FIG. 6 is a pictorial snapshot illustrating a side view of a multistair-shaped adapter frame or multi-tiered adapter frame in accordance with an aspect of the present invention;

FIG. 7 is a pictorial snapshot illustrating a side view of a Multi-tiered adapter frame or multi-tiered frame in accordance with an aspect of the present invention;

FIG. 8 is a pictorial snapshot illustrating a perspective view of the fiber enclosure including a single multistair-shaped adapter frames in accordance with an aspect of the present invention;

FIG. 9 is a pictorial snapshot illustrating a perspective view of the fiber enclosure before the mounting of Multi-tiered adapter frames in accordance with an aspect of the present invention;

FIG. 10 is a pictorial snapshot illustrating a perspective view of a fanout unit in accordance with an aspect of the present invention;

FIG. 11 is a pictorial snapshot illustrating a perspective view of the fiber enclosure representing pivotable splice holder plates in accordance with an aspect of the present invention;

FIG. 12 is a pictorial snapshot illustrating a perspective view of the multistair-shaped adapter frame representing mounting features and adapter block openings according to embodiments as disclosed herein

FIGS. 13A & 13B are pictorial snapshots illustrating a side view of the single-piece integrated adapter block representing mounting features in accordance with an aspect of the present invention;

FIGS. 14, 15, 16 are pictorial snapshots illustrating a perspective view mounting of single-piece adapter block onto the multi-tiered adapter frame in accordance with an aspect of the present invention;

FIG. 17 is a pictorial snapshot illustrating a side view of the adapter frame representing cable routing fingers arranged in a vertically offset manner in accordance with an aspect of the present invention;

FIG. 18 is a pictorial snapshot illustrating a side view of the adapter frame representing mounting of a cable routing finger in accordance with an aspect of the present invention;

FIG. 19 is a pictorial snapshot illustrating a perspective view of a multi-tiered adapter frame with single-piece integrated adapter blocks.

FIG. 20 is a pictorial snapshot illustrating a perspective view of a fiber enclosure base with a cable clamp assembly in accordance with an aspect of the present invention;

FIG. 21 is a pictorial snapshot illustrating a perspective view of a splitter bulkhead unit in accordance with an aspect of the present invention;

The fiber enclosure is illustrated in the accompanying drawings, which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DESCRIPTION OF EMBODIMENTS

Those skilled in the art will be aware that the present invention is subject to variations and modifications other than those specifically described. It is to be understood that the present invention includes all such variations and modifications. The invention also includes all such steps, features, compositions and compounds referred to or indicated in this specification, individually or collectively, and any and all combinations of any or more of such steps or features.

### Definitions

For convenience, before further description of the present invention, certain terms employed in the specification, and examples are collected here. These definitions should be read in the light of the remainder of the invention and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”. Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The following brief definition of terms shall apply throughout the present invention:

The term “optical fiber” as used herein refers to a light guide that provides high-speed data transmission. The optical fiber has one or more glass core regions and a glass cladding region. The light moving through the glass core regions of the optical fiber relies upon the principle of total internal reflection, where the glass core regions have a higher refractive index (n1) than the refractive index (n2) of the glass cladding region of the optical fiber.

The term “optical fiber cable” as used herein refers to a cable that encloses one or more optical fibers.

Fiber enclosure—Cabinet in FTTH systems managing optical fiber distribution and connection.

Input ports—Holes on sidewalls receiving input cables.

Input Cable—Feeder or distribution cable carrying signals and may have Intermittently Bonded Ribbon (IBR) bundles.

Optical fiber bundle—Collection of optical fibers.

Intermittently Bonded Ribbon—4, 8, 12, 16, 24, 48 fibers bonded intermittently in staggered pattern with 150-250 μm pitch at bonded regions.

IBR Bundle or IBR bundle segment—Grouping of IBRs; segment comprises ≥1 IBR.

Pitch at bonded region: The pitch is a distance between the center of one fiber and the center of the adjacent fiber at the bonded region. In the IBR cable of the present invention the pitch at the bonded region is in the range of 150 to 250 micrometers. This range of pitch in IBR cable ensures precise fiber alignment, which is essential for low-loss mass fusion splicing. The pitch in the range of 150-250 micrometers ensures proper fiber alignment, low splice loss, and compatibility with fusion splicing tools. Below 150 μm, fibers forming part of the IBR cable risk microbending and damage; above 250 μm, alignment and handling issues arise due to excessive spacing.

Staggered Bonding Pattern—In staggered bonding pattern, instead of being continuously bonded together, the optical fibers are joined at specific, offset points along their length. This creates an IBR cable that is less rigid than a traditional, continuously bonded ribbon cable. The intermittent, staggered points act as hinges and allow IBR cable to bend and flex more easily. The staggered bonding improves the flexibility of an optical forming part of the IBR cable while allowing for mass splicing, where multiple fibers are spliced at once. This dual advantage allows for efficient cable routing and management in tight spaces without damaging the fibers or causing signal loss.

Breakout assembly: Splits IBR bundle into bond-preserved segments via furcation tubes.

Fan-out unit: Separates multi-fiber bundle into individual fibers in protective tubing.

Feeder fanout unit: Handles feeder or distribution fibers to adapter ports.

Distribution Fanout Unit: Distribution fanout unit is configured to receive optical fibers or ribbons from distribution input cable and separate them out into individual fibers to mate with adapter ports.

Segregated routing of fibers: Physically separates fiber groups to prevent interference.

Adapter frame: Multi-tiered stair-shaped frame with step portions (offset 11.6-12.5 mm, depth 15-26.5 mm) and risers mounting adapters.

Single-piece integrated adapter—Molded block with 8-12 dual-port sub-adapters; snap-fit mounted.

Step/Riser portion: Horizontal mounting surface; vertical/curved transition.

Vertical offset: vertical offset refers to a difference in elevation or height between two points, surfaces, or components.

Adapter ports:—Connection points; feeder/distribution ports mate respective fibers.

Feeder Adapter Port: Feeder Adapter Port is a port of an optical adapter configured to mate with optical fiber of feeder input cable.

Distribution Adapter Port: Distribution Adapter Port is a port of an optical adapter configured to mate with optical fiber of feeder input cable.

Cable Routing Fingers: Removable guides on step portions, vertically offset for bend control.

Front Access Direction (A)—Accessible from front with cover open.

Splicing Region: Area with pivotable stacked splice holder plates for mass fusion.

Splitter: Passive device dividing signal (e.g., 1×8 to 1×64).

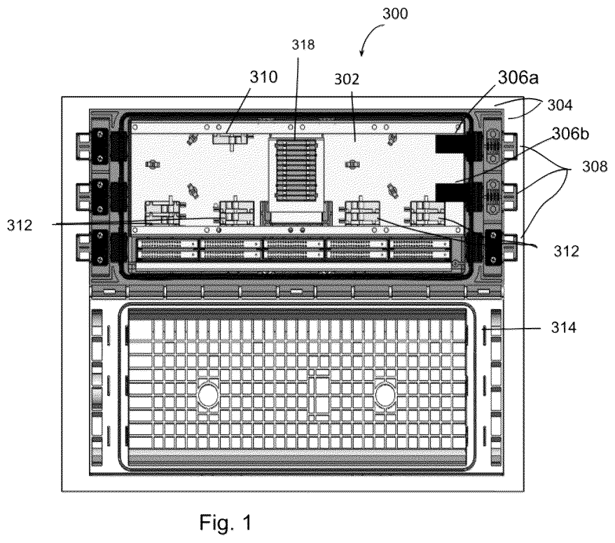

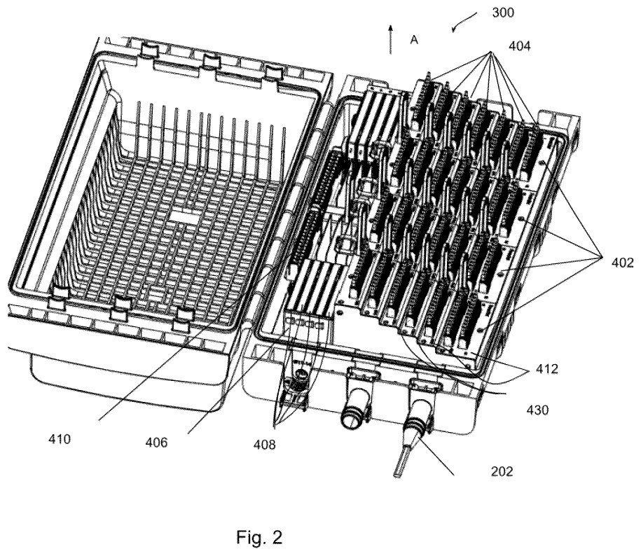

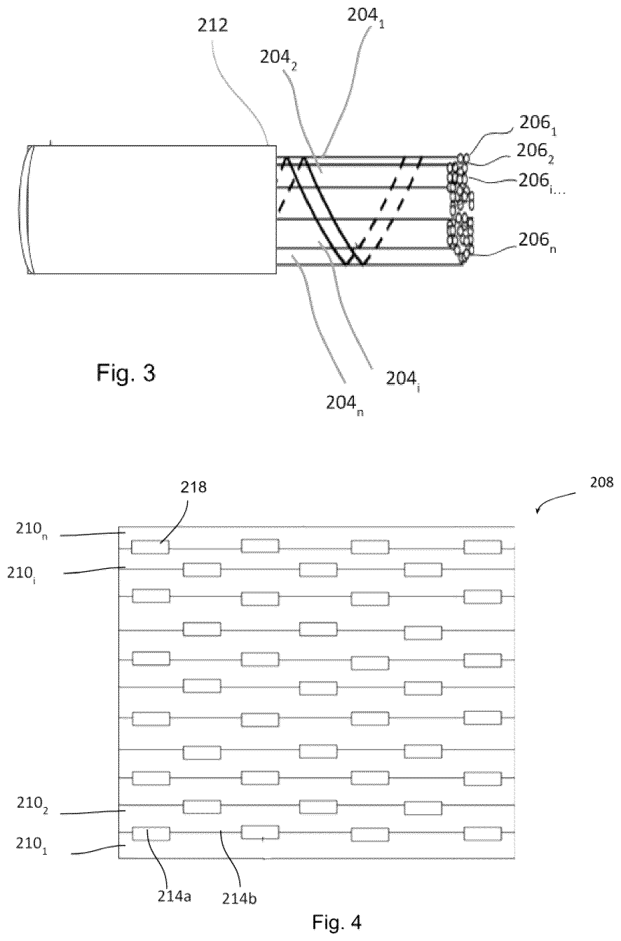

The present invention is intended for distribution of optical fibers forming part of one or more input cables. Thus, before going into elaborating the construction of the fiber enclosure (300) as disclosed in FIG. 1 and FIG. 2 (explained below), construction of the input cable (202) as disclosed in FIG. 3 and FIG. 4 is explained.

FIG. 1 and FIG. 2 are pictorial snapshots illustrating a front view and side view of a fiber enclosure with multiple fiber management components, in accordance with an aspect of the present invention. The fiber enclosure (300) for the distribution of optical fibers forming part of a plurality of input cable (202), as shown in FIGS. 3 and 4. Although FIG. 1 and FIG. 2 visually illustrate a single input cable (202) for clarity, the fiber enclosure (300) is configured to manage multiple cables via its input ports (308). Further, the fiber enclosure (300) is typically utilized in high-density telecommunication environments to manage fiber termination and connectivity. Additionally, the input cables (202) may include a plurality of feeder input cables and a plurality of distribution input cables.

In accordance with an embodiment of the present invention, the fiber enclosure (300) comprises a housing that has a base (302), a plurality of sidewalls (304), and a removable or openable cover (314). One or more input ports (308) are provided on the sidewalls (304), allowing the introduction of input cables (202) containing optical fiber bundles (204) into the fiber enclosure (300). Within the housing, fanout units (310, 312) are arranged to divide the incoming fiber bundles into individual optical fibers for further routing.

In particular, the housing cover (314) is secured to the base (300) via a latch mechanism (not shown) that engages a corresponding strike element on the base (302). Moreover, the latch release actuator is only accessible when the cover (314) is moved to a partially opened position. When the cover (314) is in the fully closed position, the release actuator is mechanically blocked by a concealing flange, which is an integrated structural portion of the cover (314). To transition to the partially opened position approximately one centimeter at the edge opposite the hinge, the cover (314) pivots away, causing the concealing flange (314f) to move clear of the latch actuator, thus exposing it for manipulation. Further, this two-step sequence prevents accidental release due to vibration or unintended contact, thereby restricting inadvertent or unauthorized access to the housing's contents.

In accordance with an embodiment of the present invention, the plurality of fanout units (310, 312) includes at least one feeder fanout unit (310) and a plurality of distribution fanout units (312). In particular, the feeder fanout unit (310) is configured to divide the fibers of the feeder input cable into individual fibers for further termination. Further, each distribution fanout unit (312) is configured to divide the fibers of the distribution input cable into individual fibers for further termination.

In accordance with an embodiment of the present invention, the fiber enclosure (300) housing comprises a plurality of breakout assemblies (306a, 306b) coupled to the input ports (308). Further, each breakout assembly (306a, 306b) is configured to divide an IBR bundle (204) into a plurality of IBR bundle segments (2061, 2062, . . . 206i, . . . 206n) while preserving intermittent bonding within each IBR (208) forming part of the IBR bundle segment (206).

It is to be explicitly understood that, although the present patent specification utilizes the example and terminology related to IBR (Intermittently Bonded Ribbon) optical fiber cables and IBR bundles for the detailed description of certain embodiments, the scope of the present invention is not limited solely to the management of such optical fiber cables. In particular, the fiber enclosure (300) and its components are equally applicable and fully compatible with any other suitable type of optical fiber cable and corresponding fiber bundle configuration, including, but not limited to, loose tube cables, fully bonded ribbon cables, flat cables, or any other type of high-fiber-count cable used in telecommunications infrastructure.

In alternative embodiments, the optical fibers from the incoming fiber bundles (204) can be fed directly to the fanout units (310, 312) or other fiber management components, bypassing the breakout assembly (306) entirely.

In accordance with an embodiment of the present invention, the plurality of single-piece integrated adapter blocks (404) are mounted on a plurality of step portions (412) (412) of a plurality of multi-tiered adapter frames (402) (explained below) provided within the housing of the fiber enclosure (300). In particular, each single-piece integrated adapter block (404) is mounted perpendicularly to the surface of a respective step portion (412). Further, the mounting angle is perpendicular, wherein the central axis of the adapter block (404) is oriented substantially at 90° to the plane of the step portion (412). Alternatively, the mounting angle is angled, being oriented at approximately 45° or 135° relative to the step portion (412). These angled configurations enable the adapter ports (422a) of the adapter block (404) to face toward a front access direction (A) of the assembly, allowing users to perform insertion, removal, and inspection operations from the front side without disturbing adjacent connections.

In yet another embodiment of the present invention, the adapter block (404) is mounted on a curved or non-linear mounting surface, wherein the curvature is defined along an arc or contoured profile that gradually transitions between the riser portion (430) and the step portion (412). Further, the curved mounting configuration provides a smooth alignment path for the incoming or outgoing optical fiber, maintaining the required minimum bend radius (e.g., 5 mm or 7.5 mm) while preserving a compact geometric profile.

In accordance with an embodiment of the present invention, the selection of the mounting angle from among perpendicular, angled between 80° to 100°, or curved configurations provides design flexibility to accommodate varying adapter frame geometries and fiber routing constraints.

In accordance with an embodiment of the present invention, each single-piece integrated adapter block (404) contains between 8 and 12 integrally molded sub adapters, thereby providing multiple connection ports within a condensed structure. In particular, each of the sub adapters is a dual-port sub adapter configured to allow optical coupling between two connectors. Further, the single-piece integrated adapter blocks (404) are aligned such that one of the ports (422a) of each sub adapter (422) is accessible from a common front access direction (A), allowing high-density patching operations.

In accordance with an embodiment of the present invention, the fiber enclosure is configured to house a splitter bulkhead unit (406) formed by the plurality of splitter cassettes (408) mounted in the frame (422). In particular, the splitter bulkhead unit (406) is removably housed in the fiber enclosure. Moreover, the splitter cassettes (408) are mounted within the frame such that the input and output ports are arranged horizontally. Further, the horizontal arrangement allows for use of space and simplifies the routing of optical fibers within the enclosure.

In accordance with an embodiment of the present invention, within the fiber enclosure (300), connector holders (410) are provided to store unused connectors from splitter outputs. In particular, the connector holders have the capacity to install up to 64 unused connectors of splitter output. Moreover, these connector holders (410) secure and organize the unused connectors, preventing damage and maintaining organization within the fiber enclosure. Further, the holders are designed with snap-in features to ensure a secure fit and easy access for technicians.

FIG. 3 is a pictorial snapshot illustrating a perspective view of one of the input cables in accordance with an aspect of the present invention. Each input cable (202) of the one or more input cables (202) comprises at least one intermittently bonded ribbon (IBR) bundle (204₁, 204₂, . . . 204ᵢ, . . . 204ₙ) housed in a protective jacket (212). Moreover, each IBR bundle (204) comprises one or more IBR bundle segments (206₁, 206₂, . . . 206ᵢ, . . . 206ₙ) bunched together. Further, each IBR bundle segment (206) comprises at least one IBR (208). It may however be noted that each IBR bundle (204) comprises the plurality of IBRs (208).

FIG. 4 is a pictorial snapshot illustrating a detailed view of IBR bundle segments representing the structure of intermittently bonded ribbon optical fibers in accordance with an aspect of the present invention. In particular, a plurality of IBRs (208) are enclosed inside the input cable (200) that require high fibre counts within less installation space. Moreover, the IBR (208) is mechanically robust. In addition, the IBR (208) is capable of handling and manufacturing operations due to the strong mechanical strength. Further, the IBR (208) is flexible. The flexibility of the IBR (208) allows the IBR (208) to roll easily.

In accordance with an embodiment of the present invention, the IBR (208) comprises 12 optical fibers (210₁, 210₂, . . . 210ᵢ, . . . 210ₙ) where the adjacent optical fibers are bonded intermittently with a matrix material in a staggered bonding pattern such that pitch at a bonded region (214 a) is in the range of 150 to 250 micrometers. In particular, the plurality of optical fibers (210₁, 210₂, . . . 210i, . . . 210n) may comprise an unbonded region (214_{b}). Further, it may be noted that the IBR (208) can comprise more than 12 optical fibers.

In accordance with alternate embodiment of the present invention, the IBR (208) comprises 4 optical fibers where the adjacent optical fibers are bonded intermittently with a matrix material in a staggered bonding pattern such that pitch at a bonded region (214 is in the range of 150 to 250 micrometers.

In accordance with alternate embodiment of the present invention, the IBR (208) comprises 8 optical fibers where the adjacent optical fibers are bonded intermittently with a matrix material in a staggered bonding pattern such that pitch at a bonded region (214 is in the range of 150 to 250 micrometers.

Further, an IBR (208) comprises plurality of optical fibers (210₁, 210₂, . . . 210ᵢ, . . . 210ₙ), where the adjacent optical fibers are bonded intermittently with a matrix material in a staggered bonding pattern such that pitch (218) at a bonded region (214ₐ) is in the range of 150 to 250 micrometers.

In accordance with an embodiment of the present invention, an IBR (208ᵢ) may comprise plurality of optical fibers (210₁, 210₂, . . . 210ᵢ, . . . 210ₙ), where the adjacent optical fibers are arranged in parallel and bonded intermittently with a matrix material in a staggered bonding pattern such that pitch (218) at a bonded region (214ₐ)is in the range of 150 to 250 micrometers.

In accordance with an embodiment of the present invention, the optical input cable may comprise optical fibers of the ITU-T G.657.A2 category. The G.657.A2 fiber is selected to ensure reliable optical performance under compact routing conditions within fiber enclosure (300). The G657.A2 fiber provides a minimum allowable bend radius of approximately 5 mm or 7.5 mm (or 5 mm) at the fiber centerline, enabling the fiber to be routed along curved guiding surfaces or riser portions of the adapter frame without exceeding its mechanical or optical limits. This characteristic allows the overall assembly to achieve high packing density while maintaining low insertion loss and long-term durability.

Further, the enclosure structurally enforces usage of optical fibers with minimum optical fiber bend radius of 5 mm or 7.5 mm (G.657.A2) or 5 mm (G.657.B3). The horizontally-extending step portions (412) of depth D=15-26.5 mm are vertically offset by riser portions (430) of height H=11.6-12.5 mm. Invention may not be bound by the theory including the minimum enforceable bend radius at the step-riser transition is:

$${R}_{min} \geq ( {D}^{2} + {H}^{2} ) / ( 2 H$$

For G.657.A2 compliance (≥5 mm or 7.5 mm):

$$Minimum claimed geometry D = 15 mm , H = 11.6 mm : {R}_{min} = ( 255 + 134.56 ) / 23.2 = 359.56 / 23.2 \approx 15.5 mm \to > 5 mm or 7.5 mm ( safe margin ) ;$$

$$D = 7 mm , H = 7 mm : {R}_{min} = 98 / 14 = 7. mm \to < 5 mm or 7.5 mm \to VIOLATION ;$$

$$D = 6 mm , H = 6 mm : {R}_{min} = 72 / 12 = 6. mm \to < 5 mm or 7.5 mm \to VIOLATION$$

For G.657.B3 compliance (≥5 mm):

$$Same minimum claimed geometry D = 15 mm , H = 11.6 mm : {R}_{min} \approx 15.5 mm \to >> 5 mm ( > 3 \times margin ) ;$$

$$D = 5 mm , H = 5 mm : {R}_{min} = 50 / 10 = 5. mm \to = 5 mm ( limit case , no margin ) ;$$

$$D = 4.5 mm , H = 4.5 mm : {R}_{min} = 40.5 / 9 = 4.5 mm \to < 5 mm \to VIOLATION ;$$

$$D = 4 mm , H = 4 mm : {R}_{min} = 32 / 8 = 4. mm \to < 5 mm \to VIOLATION .$$

The lower bounds (D≥15 mm, H≥11.6 mm) are design-optimized to guarantee Rₘᵢₙ≥15.5 mm at the minimum configuration—far exceeding both standards and accounting margin of safety for practical field usage.

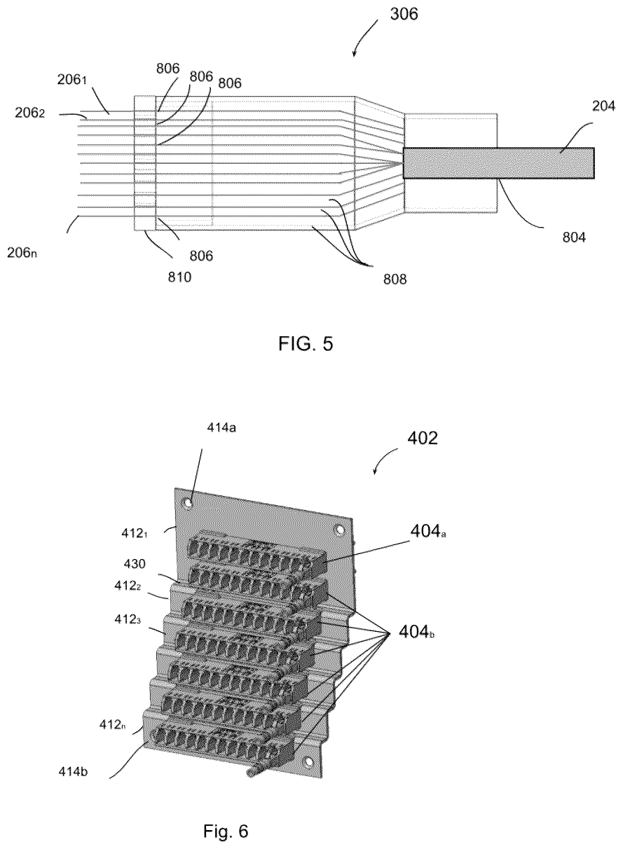

FIG. 5 is a pictorial snapshot illustrating a schematic view of an IBR bundle separation process within a breakout assembly in accordance with an aspect of the present invention. The breakout assembly (306) comprises a housing (802) that has an opening (804) to receive the IBR bundle (204) and a plurality of through holes (806) arranged to output IBR bundle segments (206) of the IBR bundle (204) into furcation tubes. Moreover, the breakout assembly (306) ensures that the bonding between fibers remains intact as the IBR bundle is subdivided into smaller groups—such as IBR bundle segments of 4 to 48 fibers—without severing the bonds between these 4 to 48 fibers. Further, each smaller fiber group is subsequently protected by furcation tubing (not shown), maintaining fiber integrity and enhancing operational reliability.

In accordance with an embodiment of the present invention, the breakout assembly (306) has multiple sets of through holes (806) arranged in rows, with each row corresponding to a segment of the Intermittently Bonded Ribbon (IBR) bundle. The through holes in adjacent rows are staggered relative to each other. further, the outer diameter of each of the through hole is approximately 3 mm with each through hole is spaced apart by approximately 5 mm to allow smooth routing of the IBR bundle segments, prevent contact between the adjacent IBR segments, and to avoid cracks between the through holes.

In accordance with an embodiment of the present invention, the housing of the breakout assembly has a base part and a cover part (not shown). In particular, the base part has slots (808) that align the Intermittently Bonded Ribbon (IBR) bundle segments, while the cover part features projections that, when closed, press the IBR bundle segments securely into these slots. Further, this arrangement of slots and projections functions together to position the IBR bundle segments relative to the staggered rows of through holes (406).

In an exemplary example, when the cover is closed, the projections gently push the IBR bundle segment into the corresponding slots, holding it firmly in place and guiding each IBR segment toward the appropriate through hole (406), thereby preventing crossing, tangling, or misalignment during the breakout process. Further, the opening (804) of the breakout assembly (306) is sized to receive an IBR bundle (204) having fiber count between 12 and 10800 fibers, preferably between 12 and 288 fibers.

In accordance with an embodiment of the present invention, the housing of the breakout assembly (306) may further comprise an integral strain relief mechanism configured to secure the IBR bundle (204) and furcation tubes for protecting the IBR bundle segments (2061, 2062, . . . 206i, . . . 206n).

To provide strain relief mechanism, a heat shrink tube (HST) (not shown) may be used at the opening (804) of the breakout assembly (306) where the IBR bundle (204) enters. It provides strain relief by absorbing mechanical stress and preventing the IBR bundle (204) from transferring the mechanical stress directly to the delicate fiber cores, which could otherwise cause bending, micro-bending losses, or breakage. The strain relief mechanism also offers securement by tightly holding the IBR bundle (204) in place as it enters the breakout assembly (306), preventing movement or slippage over time. Upon heating, the heat shrink tube shrinks around the IBR bundle (204), an internal adhesive (of the heat shrink tube) bonds to the surface of the IBR bundle (204) that ensures a firm and sealed fit.

In accordance with an embodiment of the present invention, the furcation tubes (not shown) are used at the plurality of through holes (806) of the breakout assembly (306) to protect the IBR bundle segments. Further, the number of furcation tubes is equal to the number of through holes (806) of the breakout assembly (306) such that each furcation tube houses an IBR bundle segment (206). So, if there are 12 through holes in the breakout assembly to output 12 IBR bundle segments then there will be 12 furcation tubes for enclosing each IBR bundle segment.

In accordance with an embodiment of the present invention, the one or more breakout assemblies (306) may afford the advantage of portability to different closures/applications due to the fiber breakout ruggedness.

In accordance with an embodiment of the present invention, the housing may be cylindrical housing or a rectangular housing or conical housing or the like.

In accordance with an embodiment of the present invention, a method for accessing individual Intermittently Bonded Ribbon (IBR) bundle segments (206) from an IBR bundle (204) while maintaining the integrity of the intermittent bonding between adjacent optical fibers, the method comprising the steps of:
Step 1: Providing a fiber enclosure (300) containing a breakout assembly (306), wherein the breakout assembly (306) includes a housing comprising a base part and a cover part. The housing is configured with an opening (804) and a plurality of through holes (806), wherein the through holes (806) are arranged in staggered rows.
Step 2: Receiving at least one input cable (202) into the fiber enclosure (300), the input cable (202) comprising an IBR bundle (204), wherein the IBR bundle (204) is formed by a plurality of IBR segments that are bunched together.
Step 3: Inserting the IBR bundle (204) of the input cable (202) into the opening (804) of the breakout assembly (306).
Step 4: Positioning the IBR bundle (204) by placing the bunched IBR segments into corresponding slots provided on the base part of the housing, thereby initiating the physical separation of the bunched segments.
Step 5: Securing the IBR bundle (204) by closing the cover part onto the base part, such that projections provided on the cover part press the IBR bundle securely into the slots, thereby ensuring precise alignment of the plurality of IBR segments relative to the staggered rows of through holes (806).
Step 6: Exiting the plurality of separated IBR segments (206) from a corresponding through hole (806) of the staggered rows, wherein each IBR segment (206) retains its intermittent bonding pattern and is housed within a dedicated furcation tube.
Step 7: Routing the separated and protected IBR segment outputs (206) for subsequent routing or termination within the fiber enclosure (300).

In accordance with embodiments of the present invention, the breakout assembly (306) is specifically configured to separate an Intermittently Bonded Ribbon (IBR) bundle (204) into individual IBR segments (206) while maintaining the intermittent bonding between adjacent optical fibers within each segment.

In accordance with an embodiment of the present invention, when a high-fiber-count IBR bundle, such as a 144-fiber (144F) IBR, is introduced into the breakout assembly (306), the bundle is composed of multiple IBR bundle segments, each comprising twelve (12) fibers that are intermittently bonded together along their length. These 12-fiber ribbons are grouped together within the bundle as a collection of twelve (12×12F) IBR segments.

In accordance with an embodiment of the present invention, during the separation process, the IBR bundle (204) is guided through the opening (804) into the base part of the breakout housing. The base part includes molded slots that correspond to the nominal width and geometry of each IBR sub-ribbon segment. As the bundle is laid into these slots, the slots gently guide and laterally separate the individual IBR bundle segments without exerting shear or torsional forces on the bonded interfaces between fibers. The staggered arrangement of through holes (806) further facilitates gradual spatial separation, allowing each segment to be routed out individually without disturbing the adjacent segment.

Upon closure of the cover part onto the base part, projections on the cover apply a uniform and distributed pressure onto an outer jacket portion of the IBR bundle, not onto the fiber bond lines themselves. This ensures that the intermittent bonding regions remain intact and that no peeling or delamination occurs at the bonded zones. The mechanical interaction between the projections and the slots provides both alignment and strain relief to the fibers as they transition from the bunched configuration into individual furcation tubes.

In an exemplary example, in the case of a 144F (fiber) IBR: the breakout assembly (306) separates the bundle into twelve 12-fiber IBR segments. Each 12-fiber IBR segment exits through a dedicated through hole (806), maintaining the original 12F IBR intermittent bonding pattern. The separated IBR segments are then routed into twelve furcation tubes, which provide mechanical protection and maintain proper bend radius control.

In accordance with an embodiment of the present invention, where the input cable comprises 12F or 16F IBR IBRs, the same structural principles apply. The base slots, cover projections, and through holes are configured to correspond to the width of a single 12F or 16F ribbon, allowing the breakout assembly to separate multiple smaller bundles (e.g., multiple 12F ribbons from a 48F or 96F cable).

In all cases, the intermittent bonding between adjacent optical fibers is preserved due to: 1. controlled mechanical separation—the slots are designed to provide lateral guidance without exceeding the bonding strength threshold. 2. cover projections and staggered through holes distribute mechanical loads uniformly as the fibers transition into their respective furcation tubes.

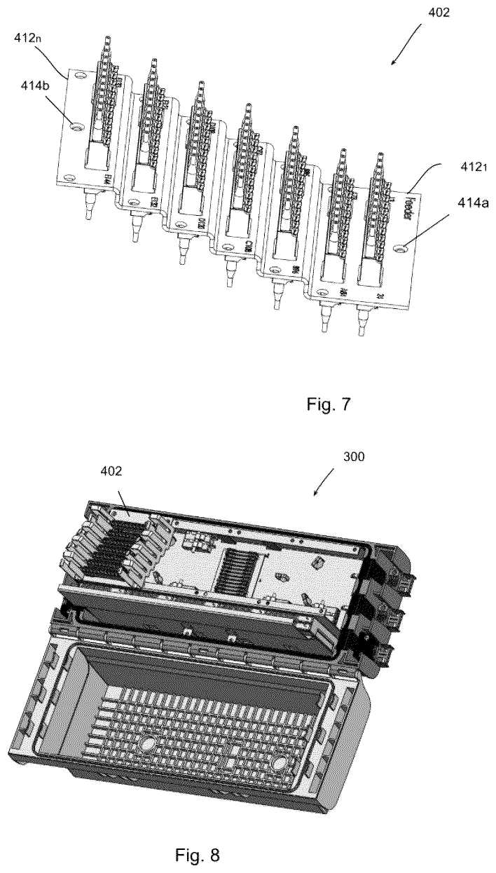

FIG. 6 and FIG. 7 are pictorial snapshots illustrating a side view of a Multi-tiered adapter frame or multi-tiered frame in accordance with an aspect of the present invention. The multi-tiered adapter frame (402) is configured to support and organize a plurality of optical fiber adapters within the fiber enclosure (300). Further, the multi-tiered adapter frame (402) comprises a plurality of step portions (4121, 4122, . . . 412i, 412n) and riser portions (430) arranged in an alternating manner, thereby forming a stair-like, tiered structure. Each step portion (4121, 4122, . . . 412i, 412n) defines a substantially horizontal surface configured to retain a plurality of adapters (404).

In accordance with an embodiment of the present invention, the riser portion (430) interconnects adjacent step portions and provides a controlled vertical offset between them. Further, the riser portion (430) may be straight, angled, or curved, and is preferably contoured to maintain a predetermined fiber bend radius when optical fibers are routed from one tier to another.

In accordance with an embodiment of the present invention, the multi-tiered configuration enables high-density arrangement of multiple adapters in a compact volume while maintaining adequate spacing for fiber routing, and connector handling. Further, the structure facilitates organized fiber management, allowing the fibers emerging from each adapter to follow a smooth, curved path along the riser portions (430), thereby minimizing micro-bending losses and mechanical stress.

In accordance with an embodiment of the present invention, the step portions (412) are arranged in a vertically staggered manner along the height of the adapter frame (402), such that each subsequent step portion is offset both vertically and horizontally relative to the previous one. In particular, the riser portions (430) define the transition zones between consecutive step portions and may include curved or inclined surfaces configured with a radius of curvature sufficient to maintain the minimum bend radius required for bend-insensitive fibers (for example, 5 mm or 7.5 mm (or 5 mm) for G.657.A2 fibers). Further, the multi-tiered arrangement provides both functional and ergonomic benefits—it enables easy access to individual adapters on different tiers, facilitates visual inspection and maintenance, and improves cable organization within the fiber enclosures (300).

In accordance with an embodiment of the present invention, the multi-tiered adapter frame (402) includes mounting features (414) provided on its first step portion (4121) and its last step portion (412n) to removably mount the adapter frame (402) within the fiber enclosure (300). Specifically, the first step portion (4121) includes at least one mounting feature (414a), and the last step portion (412n) includes at least one mounting feature (414b). In particular, the mounting features (414) may include apertures configured to receive a fastening element, such as a screw, bolt or thumb bolt, for securing the multi-tiered adapter frame (402) within the fiber enclosure (300). Moreover, the location of the mounting feature (414) is not limited to the specific illustrated position(as shown in FIG. 7 and FIG. 8); these features may be alternatively located on the central portion or on the corner of the first and last step portions. Further, the mounting features are specifically configured to receive the fastening element orthogonally (i.e., perpendicularly) to the surface of the respective step portion (412), thereby simplifying the installation and removal of the adapter frame (402).

In accordance with an embodiment of the present invention, the first step portion (4121) is provided with a width greater than the remaining step portions (4122, 4123, . . . 412n). This increased width is dimensioned to allow the mounting of two single-piece integrated adapter blocks (404) on the first step portion (4121) itself. Further, these two adapter blocks mounted on the first step portion (4121) are configured to serve distinct purposes: one is configured as a feeder adapter block (404a) for mating with terminated fibers originating from the feeder input cable, and the other is configured as a distribution adapter block (404b) to mate with terminated fibers originating from the distribution input cable. Furthermore, the plurality of distribution adapters (404b) is further mounted on the remaining step portions (4122, 4123, . . . , 412n) of the multi-tiered stair-shaped adapter frame (402).

In accordance with an embodiment of the present invention, both of the two adapter blocks mounted on the first step portion (4121) are configured as feeder adapter blocks (404a) for mating with terminated fibers originating from the feeder input cable

In accordance with an embodiment of the present invention, the multi-tiered adapter frame (402) is adaptable to different port capacity and usage requirements. Without limitation, in one exemplary embodiment, the stair-shaped frame (402) is configured to mount a total of one feeder adapter block (404a) and six distribution adapter blocks (404b). In another exemplary embodiment, the multi-tiered adapter frame (402) is configured to mount a total of two feeder adapter blocks (404a) and five distribution adapter blocks (404b).

Both the feeder adapter block (404a) and the distribution adapter block (404b) are passive optical devices configured to couple two optical fiber connectors, such as but not limited to SC-type or LC-type connectors. The distribution adapters (404b) are similarly utilized to mate with the fibers of the distribution input cables. Further, this stair-shaped design, in combination with the increased width of the first step portion (4121), allows for highly efficient utilization of vertical space within the enclosure, enabling high-density fiber management while ensuring clear functional separation between the feeder and distribution networks.

In accordance with an embodiment of the present invention, a vertical offset between adjacent step portions, defined by the height of the riser portions (430), is maintained in a range of 11 mm to 12.5 mm, and is preferably about 11.7 mm. This range is effective for maximizing both operational efficiency (easy connector access) and spatial efficiency (high port density). This height range ensures adequate vertical clearance for connector manipulation and fiber bend radius protection.

In accordance with an embodiment of the present invention, the fibers utilized in the system are of the G.657.A2 type, which has a Minimum Bend Radius 5 mm or 7.5 mm (or 5 mm). Testing has demonstrated that a riser height below 11 mm forces the routed fiber into a bend radius tighter than the minimum bend radius, specifically resulting in unacceptable signal degradation. By maintaining the offset at 11 mm or above, the design protects the fiber and allows for the use of standard LC connectors without requiring specialized, high-cost, small-form-factor connectors (such as push-pull type LC connectors).

In accordance with an embodiment of the present invention, the width of the plurality of other (non-end) step portions is maintained between 15 mm and 26.5 mm, preferably about 25.7 mm. This precise dimension optimizes horizontal density while allowing necessary component clearance. This depth range is also set to ensure optimal port accessibility by allowing the technician sufficient space to grasp and manipulate connectors without obstruction from the step above.

In accordance with an embodiment of the present invention, the vertical offset between the step portions may be a linear Offset defining the multi-tiered adapter frame (402) as a classical stair-step arrangement, where each step portion (412) is in offset by fixed vertical riser portion (430) of 11 mm to 12.5 mm. Further, the vertical offset between the step portions may be defined by a single, continuously curved surface (such as an arc or parabolic profile), ensuring the required step portion separation is achieved across a smooth transition to prioritize bend radius control. The curvature is defined by a radius of curvature maintained between 8 mm to 9 mm (minimum), which prevents abrupt transitions that would violate 5 mm or 7.5 mm (or 5 mm) minimum bend radius and compromise connector accessibility. Radius of curvature below 8 mm may increase bending losses. Radius of curvature above 10 mm may cumulatively increase the size of the multi-tiered adapter frame.

In accordance with an embodiment of the present invention, the vertical offset between the step portions may be defined as the angled riser portion, having an offset angle (θ) with respect to the adjacent step portion. The curvature of the riser portion is defined to maintain a minimum bend radius (R) for the optical fiber of at least 5 mm or 7.5 mm (or 5 mm), corresponding to the minimum allowable bend radius for a G.657.A2 optical fiber. Further, the offset angle (θ) is maintained within a range of 5° to 60°, thereby providing a compact yet safe routing path for the fibers. When the angle θ is less than 5°, the riser portion becomes excessively shallow, resulting in an increased horizontal footprint. Conversely, when the angle θ exceeds 60°, the curvature becomes excessively steep, leading to a reduction in the effective bend radius below 5 mm or 7.5 mm (or 5 mm) and inducing micro-bending stress or optical attenuation in the fiber.

Accordingly, the preferred range of the offset angle θ is 10° to 50°, which provides an optimal balance between compact design, manufacturability, and mechanical safety. Within this range, the curvature radius (Rs) of the riser portion may be between 8 mm and 10 mm, ensuring that the fiber bend radius (Rc) remains equal to or greater than 5 mm or 7.5 mm (or 5 mm).

In accordance with an embodiment of the present invention, a plurality of single-piece integrated adapter blocks (404) are arranged on each step portion (412) such that each single-piece integrated adapter block (404) is mounted perpendicularly relative to the surface of the step portion. Further, this configuration ensures that all adapter ports are accessible from a common front access direction, eliminating the accessibility issues of prior art.

In accordance with an embodiment of the present invention, the mounting angle is perpendicular, wherein the central axis of the adapter block (404) is oriented substantially at 90° to the plane of the step portion (412). Alternatively, the mounting angle (θm) is angled, being oriented at between 45° or 135° (preferably 80° to 100°) relative to the step portion (412). These angled configurations enable the adapter ports (422a) of the adapter block (404) to face toward a front access direction (A) of the assembly, allowing users to perform insertion, removal, and inspection operations from the front side without disturbing adjacent connections.

In accordance with an embodiment of the present invention, the single-piece integrated adapter block (404) is mounted on a curved or non-linear mounting surface, wherein the curvature is defined along an arc or contoured profile that gradually transitions between the riser portion (430) and the step portion (412). The curved mounting configuration provides a smooth alignment path for the incoming or outgoing optical fiber, maintaining the required minimum bend radius (e.g., 5 mm or 7.5 mm) while preserving a compact geometric profile.

Further, the selection of the mounting angle from among perpendicular, angled at 45° to 135° (preferably 80° to 100°).

In accordance with an embodiment of the present invention, the multi-tiered adapter frame (402) is dimensioned to maximize density while accommodating necessary mounting hardware and specialized adapter blocks.

In accordance with an embodiment of the present invention, the width of the first step portion (4121) is between 49 mm and 53 mm, preferably about 51 mm, and the width of the last step portion is preferably about 31 mm. A width below 49 mm for the first step portion would create a crowded region, making it difficult to accommodate the mounting features (414) along with two single-piece integrated adapter blocks (404), and a width below 31 mm for the last step portion would similarly create a crowded region for providing the mounting feature (414) along with its corresponding adapter block (404).

Further, greater widths of the first and last step portions compared to the other step portions are important. This increased width allows mounting features (414) (for attaching the frame to the housing) to be provided directly on the step portion without requiring additional risers or steps, thereby saving vertical space. Further, the wider first step portion (4121) allows for the mounting of two single-piece integrated adapter blocks. In a splitter embodiment, one adapter block is used as a splitter input, and the remaining adapter blocks are used for splitter outputs, efficiently maximizing port count within the frame size.

FIG. 8 is a pictorial snapshot illustrating a perspective view of the fiber enclosure including a single multistair-shaped adapter frame in accordance with an aspect of the present invention.

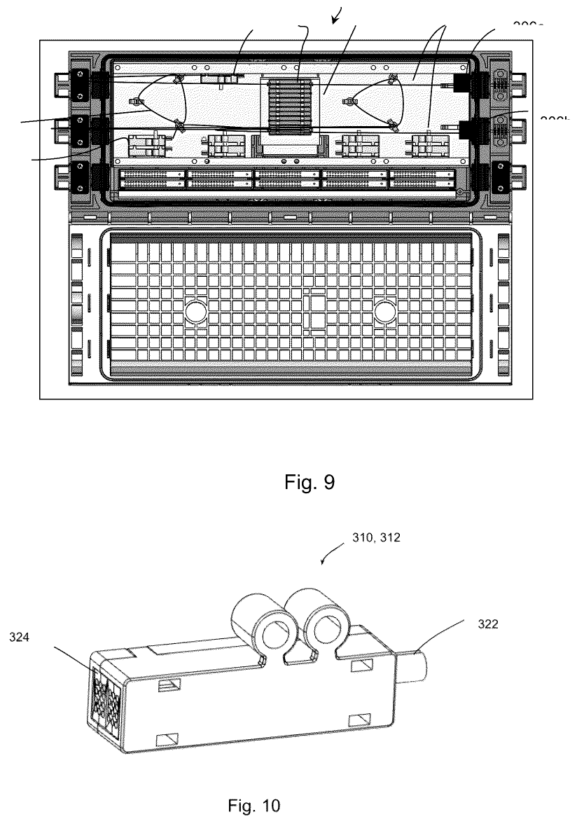

FIG. 9 is a pictorial snapshot illustrating a perspective view of the fiber enclosure before the mounting of Multi-tiered adapter frames in accordance with an aspect of the present invention. The fiber enclosure (300) without mounting of the multi-tiered adapter frames (402) is disclosed herein. In particular, the fiber enclosure (300) includes a feeder breakout assembly (306a) and a distribution breakout assembly (306b). Moreover, the feeder breakout assembly (306a) is configured to receive a feeder input cable and the distribution breakout assembly (306b) is configured to receive a distribution input cable. In an example, but not limited to, the feeder input cable may be an IBR bundle of 2 IBR bundle segments of 12 fibers. Further, the distribution cable breakout assembly (109b) receives the distribution input cable as an input. In an example, but not limited to, the distribution input cable may be a 288 fiber input cable, having an IBR bundle of 24 IBR segments of 12 fibers.

The breakout assemblies (306a, 306b) are configured to separate the IBR segments from the IBR bundle, while maintaining the intermittent bonding between the adjacent fibers of the IBR with features such as strain relief mechanisms to prevent damage to the fibers during installation and operation.

In accordance with an embodiment of the present invention, the feeder fanout unit (310) is coupled directly to the feeder breakout assembly (306a) and provides individual fiber output for further termination. Further, the feeder fanout unit (310) provides a 2*24F fanout output.

In accordance with an embodiment of the present invention, the distribution fanout unit (312) is coupled to a splicing region (600) using an IBR bundle segment (206) and provides individual fiber fanout as output for further termination. Further, the distribution fanout unit (312) provides a 3*24F fanout output.

In accordance with an embodiment of the present invention, the IBR bundle segments exiting from the distribution breakout assembly (306b) are routed towards the splicing region (600) provided on the base (302) of the fiber enclosure (300). In particular, the splicing region (600) is equipped with splice trays or holders (318) to securely position the fibers during the splicing process. Further, the trays are used to accommodate both single and mass fusion splices, providing flexibility in splicing operations.

In accordance with an embodiment of the present invention, the distribution fanout unit (312) is configured to receive optical fibers or ribbons directly from a distribution input cable or from the distribution breakout assembly (306) and separate the same into individual fibers. In particular, the distribution fanout unit (312) may include features such as strain relief and protective tubing to ensure the fibers are not damaged during the separation process. Further, the design of the fanout unit with an integrated cable spool ensures that the fibers are routed with minimal bending and stress, maintaining the integrity of the optical signal.

In accordance with an embodiment of the present invention, the fiber enclosure (300) employs IBR cables to achieve cost savings through mass fusion splicing. Alternatively, standard non-IBR loose-tube cables or multi-tube cables may be utilized with the fiber enclosure (300). The use of IBR cables allows for higher fiber density and more splicing operations, reducing the overall cost and complexity of the fiber management system. Further, the enclosure is used to be compatible with a variety of cable types, providing flexibility in deployment and maintenance.

FIG. 10 is a pictorial snapshot illustrating the fanout unit (310, 312), which has a housing with an opening (322) sized to receive an IBR bundle segment and a plurality of through holes (324) sized to output individual fibers. In particular, the feeder fanout and the distribution fanout utilize fanout units that have a similar structural design for their housings. The defining difference between the resulting feeder fanout unit (310) and the distribution fanout unit (312) is the total number of fanout units incorporated into each.

For example, a feeder fanout unit (310) may be defined by two fanout units, while a distribution fanout unit (312) may be defined by three fanout units.

In accordance with an embodiment of the present invention, a cable spool (not shown) is fixed within the housing of the fanout units (310, 312) and having a central core around which a portion of the IBR bundle segment is wound to provide manageable slack. Further, the cable spool also has radial slots designed to separate the fiber bundle into individual fibers or small groups, ensuring organized fanout. These functionalities of compact cable storage and orderly fiber separation within a single component improve cable management.

In accordance with an embodiment of the present invention, the cable spool has a cylindrical shape with an annular groove forming the central core for winding the cable. Further, radial slots are formed on an outer flange of the spool, extending outward to provide organized pathways for the individual fibers. This geometry optimizes space utilization and enables a smooth transition from the wound cable to separated fibers.

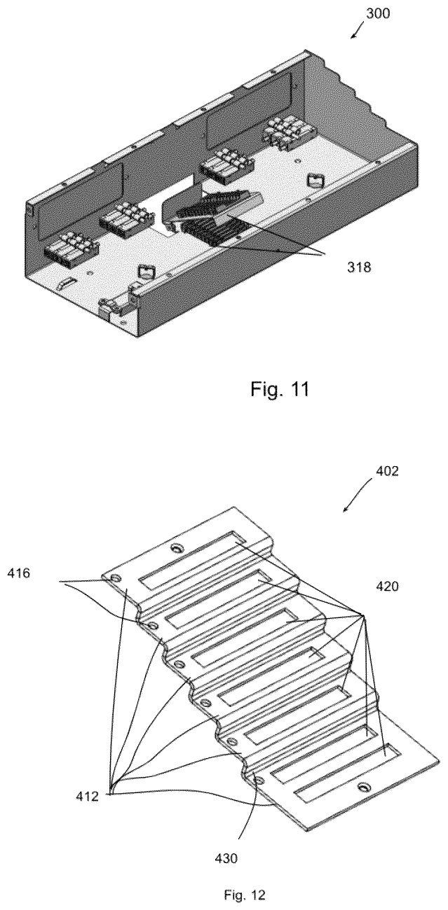

FIG. 11 is a pictorial snapshot illustrating a perspective view of the fiber enclosure (300) representing internal splicing components according to embodiments disclosed herein. The plurality of splice holder plates (318) pivotably connected to each other in a vertically stacked manner. In particular, each splice holder plate (318) includes a plurality of splice holders configured to secure spliced optical fibers. Further, the stacked splice holder plates (318) allow access to individual splice holder plates by pivoting the plates relative to one another, facilitating mass fusion splicing operations. The design of the splice holder plates ensures that the fibers are securely held in place during splicing, reducing the risk of damage or signal loss. In an embodiment, each splice holder is configured to store or protect mass fusion splicing of 4N fibers, where N is an integer between 1 and 10.

In accordance with an embodiment of the present invention, the mass fusion splicing process is carried out using a stacked splice holder plate (318) designed to accommodate and protect multiple optical fiber splices in a compact and organized arrangement. In particular, each splice holder plate (318) comprises a plurality of individual splice holders, each configured to secure one or more optical fibers during and after the fusion splicing operation. Moreover, the splice holders are arranged along the splice holder plate (318) to facilitate efficient fiber routing and to maintain consistent fiber alignment and bend radius control. Further, the plates are mounted in a stacked configuration, wherein adjacent splice holder plates are pivotally coupled, enabling selective access to any individual plate by pivoting it relative to the others. This pivoting mechanism allows for ergonomic handling and easy inspection or maintenance of specific splices without disturbing neighboring fibers or plates.

In accordance with an embodiment of the present invention, during the mass fusion splicing process, corresponding sets of optical fibers are prepared by stripping, cleaning, and cleaving their ends to ensure precise alignment. The prepared fibers are then positioned within the splice holders.

In accordance with an embodiment of the present invention, a mass fusion splicer is used to simultaneously fuse multiple fibers, typically in sets of four (4N fibers, where N is an integer between 1 and 10), using controlled electric arc heating to melt and join the fiber ends with high precision. The use of the 4N configuration allows for efficient batch processing, significantly reducing splicing time while maintaining high optical performance and low splice loss.

Once fusion is complete, the spliced fibers are carefully placed into the corresponding splice holders, where they are secured to prevent movement or mechanical stress. The stacked and pivotable arrangement of splice holder plates further enhances accessibility, enabling technicians to perform mass splicing, inspection, and rework operations with minimal handling of the fiber bundle. This design minimizes the risk of fiber damage or signal degradation and optimizes workflow efficiency in high-density fiber management systems.

FIG. 12 is a pictorial snapshot illustrating a perspective view of a multi-tiered adapter frame according to embodiments disclosed herein. In particular, the multiple multi-tiered adapter frames (402) (collectively and interchangeably referred to as the adapter frame (402)) include a plurality of step portions (4121-412n) (collectively referred to as 412) separated by riser portions (430). Moreover, each step portion (412) lies in a horizontal plane vertically offset from adjacent step portions (412), forming a stair arrangement. Further, the riser portions (430) provide the necessary vertical separation between the step portions (412), ensuring that the fibers are routed with minimal bending and stress.

In accordance with an embodiment of the present invention, the first step portion (4121) is provided at a lower end of the multi-tiered adapter frame (402). The last step portion (412n) is provided at an upper end of the multi-tiered adapter frame (402). Moreover, the riser portions (430) extend vertically between adjacent step portions (412) to define the vertical offset between the step portions. Further, the step portions (412) are used to accommodate standard optical adapters, with each step providing a secure mounting point for the adapters. Furthermore, a plurality of openings (420) are provided on each of the step portions (412) where each of the openings (420) are configured to receive a single-piece integrated adapter block (404).

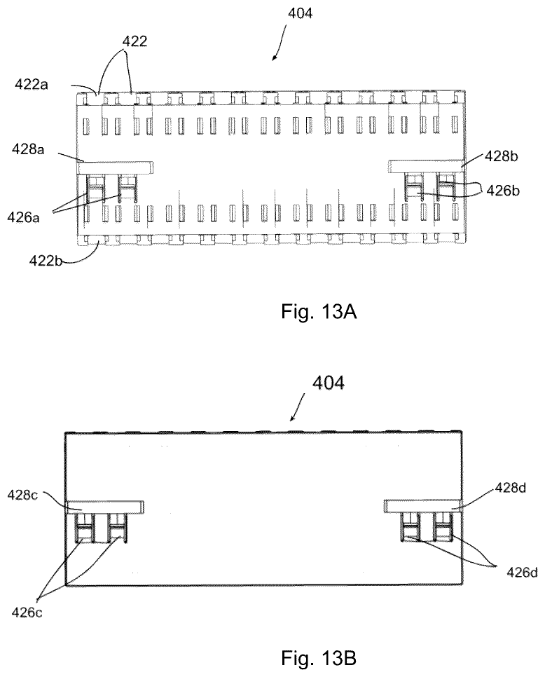

FIG. 13 is a schematic representation illustrating a front view of a single-piece integrated adapter block (404) according to embodiments disclosed herein. The single-piece integrated adapter block (404) is a unitary molded optical component configured for high-density fiber termination applications. This adapter block provides a compact solution for managing multiple optical fiber connections within a limited space while maintaining accessibility and serviceability. The unitary construction of the adapter block ensures consistent performance and reduces the risk of misalignment or damage during installation and maintenance. The high-density design allows for use of space in data centers and telecommunications closets, where space is often at a premium. Additionally, the integrated design minimizes the number of components, reducing the potential points of failure and simplifying inventory management.

In accordance with an embodiment of the present invention, the single-piece integrated adapter block (404) includes a plurality of sub adapters (422) arranged in a linear configuration. Each sub adapter (422) functions as a dual-port adapter configured to receive and align two optical connectors for optical coupling. These sub adapters (422) are integrally molded as part of the single-piece construction, eliminating the need for individual adapter mounting and alignment during installation. The dual-port configuration of each sub adapter allows for use of space while providing robust and reliable connections. The integrally molded design ensures precise alignment of the optical connectors, which is used for maintaining low insertion loss and high return loss in optical networks.

In accordance with an embodiment of the present invention, the linear arrangement of the sub adapters facilitates easy access and management of the optical connections, making it easier for technicians to perform maintenance and upgrades. Further, the single-piece integrated adapter block offers significantly greater structural rigidity compared to a row of small, interconnected adapters. This makes the adapter block more resistant to physical stress, vibration, and accidental impact during installation or maintenance. The adapter block allows for the tightest possible port spacing because the entire housing structure is accounted for in one mold design. This maximizes the number of ports that can fit onto the specific dimensions of your inventive multi-tiered step portion. By eliminating individual housing walls, retention clips/tabs, the single-piece integrated adapter block minimizes the non-functional space between ports. This results in a tighter physical width, maximizing the utilization of the available step width 25.7 mm (for example) and achieving a port density increase of approximately 10% to 15% compared to using individual adapters.

In accordance with an embodiment of the present invention, the single-piece integrated adapter block (404) includes at least twelve sub adapters (422) arranged in a horizontal row. In different embodiments the single-piece integrated adapter block (40) may include at least eight sub adapters (422). Each sub adapter (422) includes a first adapter port (422a) positioned on a first side of the adapter block (404) and a second adapter port (422b) positioned on a second side of the adapter block (404) opposite to the first side. The first adapter port (422a) and the second adapter port (422b) are aligned along an optical axis to enable optical coupling between two fiber optic connectors inserted from opposite sides.

In accordance with an embodiment of the present invention, the second adapter port (422b) is configured to face toward a base (302 of the fiber enclosure (300)) when the single-piece integrated adapter block (404) is mounted on a step portion (412) of the multiple multi-tiered adapter frames (402). Further, the second adapter port (422b) receives optical fibers extending from fanout units (310, 312) mounted on the base (302 of the fiber enclosure (300)).

In accordance with an embodiment of the present invention, the first adapter port (422a) is configured to face toward a cover (314) or front access direction (A) of the fiber enclosure (300), enabling technicians to connect patch cords or splitter inputs from the front side of the fiber enclosure (300). The orientation of the adapter ports (422a, 422b) ensures that the optical fibers are routed in an organized manner, reducing the risk of tangling and damage. The step portion mounting provides a clear and unobstructed path for the optical fibers, ensuring that they maintain the proper bend radius and minimizing signal loss. The front access design allows for easy monitoring and maintenance of the connections.

In accordance with an embodiment of the present invention, the single-piece integrated adapter block (404) further includes integrated mounting features configured to enable tool-free installation and removal from a step portion of a multi-tiered adapter frame (402). The integrated mounting features include a plurality of tabs (426a, 426b, 426c, 426d) and a plurality of projections (428a, 428b, 428c, 428d) allowing snap-fit mounting onto a respective step portion (412) of the multi-tiered adapter frame (402).

In accordance with an embodiment of the present invention, the tabs (426a, 426b) and the projections (428a, 428b) are provided on the front side of the single-piece integrated adapter block (404) as shown in FIG. 13a, while the other of the tabs (426c, 426d) and projections (428c, 428d) are provided on the back side of the single-piece integrated adapter block (404) as shown in FIG. 13b. The tool-free design simplifies the installation process, reducing the time and effort required to mount the adapter block. The integrated mounting features also ensure a secure and stable connection, minimizing the risk of the adapter block becoming dislodged or misaligned during operation.

In accordance with an embodiment of the present invention, these tabs (426a, 426b, 426c, 426d) establish a snap-fit locking mechanism within the opening (420) defined by the step portion (412) when the single-piece integrated adapter block (404) is inserted perpendicularly into the opening (420). The tabs (426) are used to flex during insertion and then return to their original position once fully inserted, creating a secure mechanical lock. In particular, the snap-fit mechanism ensures that the adapter block is securely mounted, minimizing the risk of it becoming dislodged or misaligned during operation. The flexible design of the tabs allows for easy installation and removal, making it simple for technicians to perform maintenance and upgrades. Further, the snap-fit locking mechanism also provides a tactile and audible indication of secure mounting, ensuring that the adapter block is consistently positioned perpendicular to the step portion.

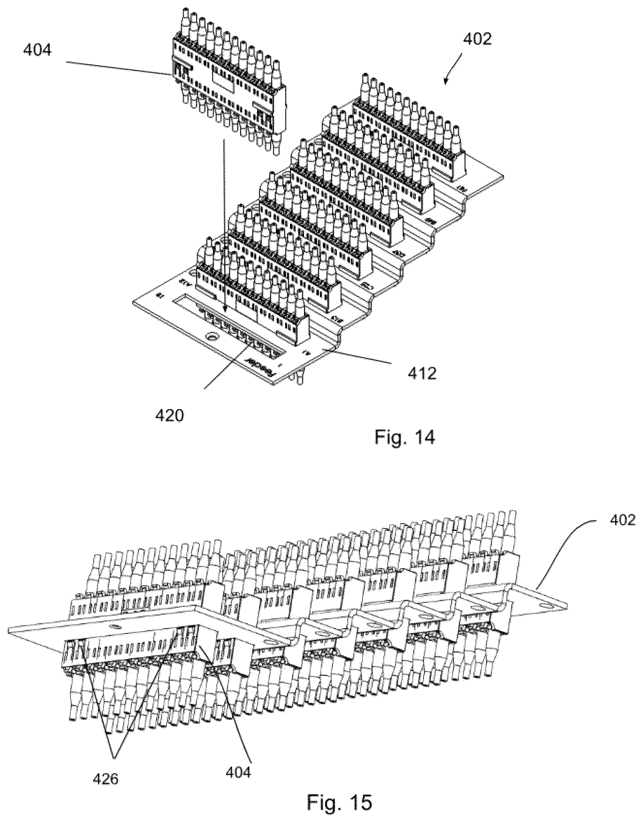

FIG. 14 and FIG. 15 are pictorial snapshots illustrating a perspective view mounting of a single-piece adapter block (404) onto a step portion (412) of a multi-tiered adapter frame (402) in accordance with an aspect of the present invention. The integrated mounting features include a plurality of tabs (426a, 426b, 426c, 426d) and a plurality of projections (428a, 428b, 428c, 428d) allowing snap-fit mounting onto the respective step portion (412). As shown in FIGS. 14a and 14b, the tabs (426a, 426b) and projections (428a, 428b) are provided on the front side, while the other tabs (426c, 426d) and projections (428c, 428d) are provided on the back side. During the mounting process, the single-piece integrated adapter block (404) is inserted perpendicularly to the opening (420) provided on the step portion (412). In this process, the tabs flex and pass through the opening while the projections stay outside the opening. When fully aligned, the tabs return to their actual position and generate an audible feedback to indicate proper alignment.

In accordance with an embodiment of the present invention, the snap-fit mechanism enables secure mounting and subsequent removal of the single-piece integrated adapter block (404) without requiring tools or loose hardware such as screws, nuts, or clamps. In particular, this mechanism provides a tactile and audible indication of secure mounting, ensuring the adapter block is consistently positioned perpendicular to the step portion (412). Technicians can quickly add or replace a complete unit of multiple adapter ports (422a, 422b) in seconds, functioning as a high-density plug-and-play module. The tool-free design simplifies the installation process, reducing the time and effort required to mount the adapter block. Further, the secure mounting provided by the snap-fit mechanism ensures that the optical connections remain stable and reliable, minimizing the risk of signal loss or disruption.

In accordance with an embodiment of the present invention, mounting and demounting of the single-piece integrated adapter block (404) are facilitated by the stair-shaped configuration of the multi-tiered adapter frame (402). The vertical offset between adjacent step portions provides clear accessibility to each adapter block, enabling technicians to securely mount or demount the single-piece integrated adapter blocks (404) without requiring specific tools via the snap-fit mechanism. In particular, the locking tabs (426) maintain the perpendicular orientation of the adapter block relative to the step portion, ensuring consistent optical alignment across all sub adapters. Moreover, the stair-shaped configuration also ensures that the optical fibers are routed in an organized manner, reducing the risk of tangling and damage. The clear accessibility provided by the vertical offset makes it easy for technicians to perform maintenance and upgrades. Further, the consistent optical alignment provided by the locking tabs ensures that the optical signals are transmitted with minimal loss and distortion, maintaining the integrity of the data being transmitted.

In accordance with an embodiment of the present invention, when the single-piece integrated adapter block is mounted, the second adapter port (422b) faces downward toward the base (302 of a fiber enclosure (300)), while the first adapter port (422a) faces upward toward a cover or front access direction of the enclosure. This orientation ensures that the optical fibers are routed in an organized manner, reducing the risk of tangling and damage. Further, the downward-facing second adapter port (422b) allows for easy optical connection to the fanout units mounted on the base, while the upward-facing first adapter port (422a) provides easy access for connecting patch cords or splitter inputs. The opposing port design also facilitates use of space within the fiber enclosure, maximizing the number of connections that can be accommodated.

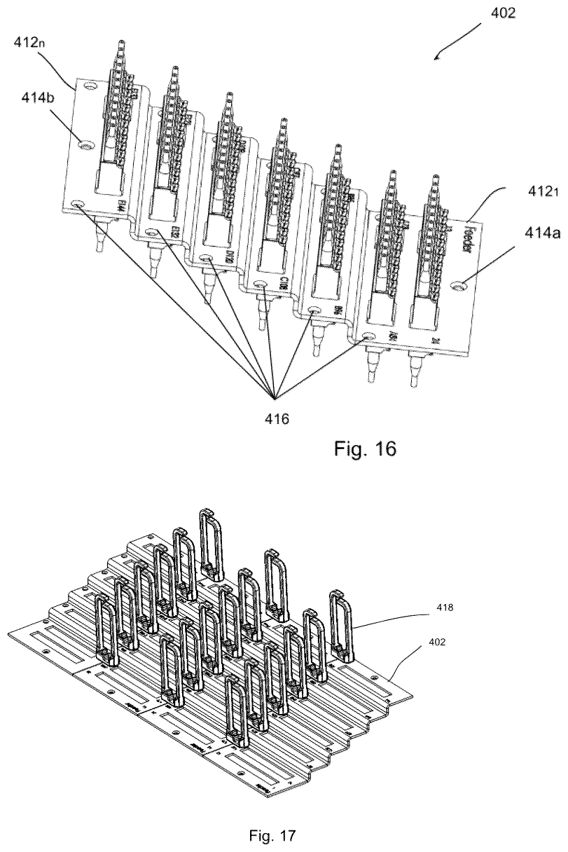

Now referring to FIG. 16 illustrating another perspective view of the multi-tiered adapter frame (402) illustrating attachment features (416) provided on each step portion for removably attaching cable routing fingers (418). In particular, the cable routing fingers (418) provide organized pathways for the fibers, preventing tangling and ensuring that the fibers are routed with minimal bending and stress. Moreover, the first and last step portions (4121, 412n) of the multi-tiered adapter frame (402) are wider than the intermediate step portions to provide sufficient surface area for directly incorporating the mounting features (414a, 414b) onto the step portions (4121, 412n) themselves, thereby eliminating the need for separate riser portions dedicated to mounting. Further, this arrangement saves space within the fiber enclosure (300) volume and allows the mounting feature to be an opening that receives a screw or similar fastener for fixing the adapter frame within the fiber enclosure (300). The wider step portions provide additional stability to the frame, ensuring that it remains securely mounted within the enclosure.

In accordance with an embodiment of the present invention, the mounting feature may be an aperture suitable for receiving a fastener such as a screw or nail to secure the adapter frame within the enclosure. In particular, the first step portion (4121) is wider than the last step portion (412n) and is adapted to support the mounting of two single-piece integrated adapter blocks (404), allowing one block to act as the feeder adapter block (404a) and the other as the distribution adapter block (404b), thereby providing additional port density within the same frame size. Further, this arrangement enables a feeder-to-distribution port ratio of approximately 1:6 within a single adapter frame and increases port capacity without increasing the number of vertical tiers or overall depth, resulting in utilization of the enclosure's internal volume.

In accordance with an embodiment of the present invention, the number of adapter blocks and step portions (412) may be varied depending on application requirements. The vertical offset between adjacent step portions (412) is maintained in the range of 11 mm to 12.5 mm to enable smooth fiber routing with sufficient clearance for 90-degree transitions while meeting the minimum bend radius requirements of optical fibers to prevent macro bending losses. The width of each intermediate step portion is maintained in the range of 15 mm to 26.5 mm to ensure compactness while allowing reliable mounting of adapter blocks on each step portion. The design ensures that the fibers are routed with minimal bending and stress, maintaining the integrity of the optical signal.

In accordance with an embodiment of the present invention, for vertical offset between adjacent step portions (412), the lower limit of 11 mm is determined based on the minimum required clearance to avoid physical interference and maintain the integrity of the fiber bend, as tests have shown that offsets below 11 mm result in increased attenuation due to excessive fiber bending and cross-contact. The upper limit of 12.5 mm is chosen to maintain a compact form factor while providing adequate segregation.

Similarly, the step depth of 15 mm to 26.5 mm is optimized to provide a sufficient bend radius margin. A depth of at least 15 mm ensures that the bend radius of the fiber does not fall below the specified minimum (e.g., 5 mm or 7.5 mm for G.657.A2 type optical fiber) even under manufacturing tolerances, while a depth up to 26.5 mm provides additional design flexibility without substantially increasing the overall size. These ranges have been selected through experimental testing, which demonstrated that within these ranges, the attenuation due to bending remained below acceptable limits (e.g., less than 0.25 dB) and no physical damage or significant crowding was observed.

In accordance with an embodiment of the present invention, in dense fiber enclosures, push-pull optical connectors are generally used for ease of operation. However, the unique geometry and dimensions of the multi-tiered adapter frame (402) eliminate the need for push-pull type optical connectors, resulting in cost savings in component selection and inventory management while maintaining high-density performance. The design of the adapter frame ensures that the connectors are easily accessible, allowing for quick and easy installation and maintenance.

In accordance with an embodiment of the present invention, the multi-tiered adapter frame (402) features a specific geometry and dimensional configuration that allows optical connections without requiring push-pull type connectors. This configuration provides cost savings in component selection and inventory management while maintaining high-density performance. The design of the adapter frame ensures that the connectors are easily accessible, allowing for quick and easy installation and maintenance. Moreover, the multiple multi-tiered adapter frames (402) overcome density, accessibility, and cable safety challenges through a stair-stepped structure. Further, the vertical offset between step portions (412) creates sufficient clearance for technicians to access every individual port without obstructing adjacent ports. The perpendicular mounting orientation of adapter blocks ensures all adapter ports are aligned horizontally and accessible from a common front access direction. The design ensures that the fibers are routed with minimal bending and stress, maintaining the integrity of the optical signal.

In accordance with an embodiment of the present invention, the multi-tiered adapter frame (402) is configured to provide clear access to each individual optical port. This configuration allows the use of standard separate connectors for each port, offering operational and economic advantages over systems that rely on proprietary ganged connectors. Further, in the event of a failure in a single optical fiber, the technician may disconnect and service only the affected connector while all other active connections remain operational. This feature ensures maximum network uptime during maintenance.

In accordance with an embodiment of the present invention, the adapter frame (402) is structurally configured to ensure unobstructed finger access to every individual connector port, thereby maximizing the operational and economic efficiency of the fiber deployment. This accessibility, facilitated by the multi-tiered, stair-step architecture, allows for the advantageous use of standard, separate, single-fiber connectors (e.g., LC connectors) rather than requiring proprietary or specialized ganged connectors.

An operational advantage is realized during maintenance: if a single fiber requires servicing or replacement, a technician can easily access, unplug, and service only that specific connector, leaving all other active connections undisturbed. This highly targeted maintenance capability ensures maximum network uptime and significantly reduces the potential for service interruption. Economically, the use of individual connectors supports granular scalability by enabling users to install only the necessary fiber capacity at any given time, thus eliminating the upfront capital expenditure and wastage associated with installing large, pre-fitted ganged connectors that contain substantial unused fiber capacity.

In accordance with an embodiment of the present invention, unused fiber connections need not be pre-installed, avoiding unnecessary initial costs associated with large pre-fitted ganged connectors. The design ensures that the fibers are routed with minimal bending and stress, maintaining the integrity of the optical signal.

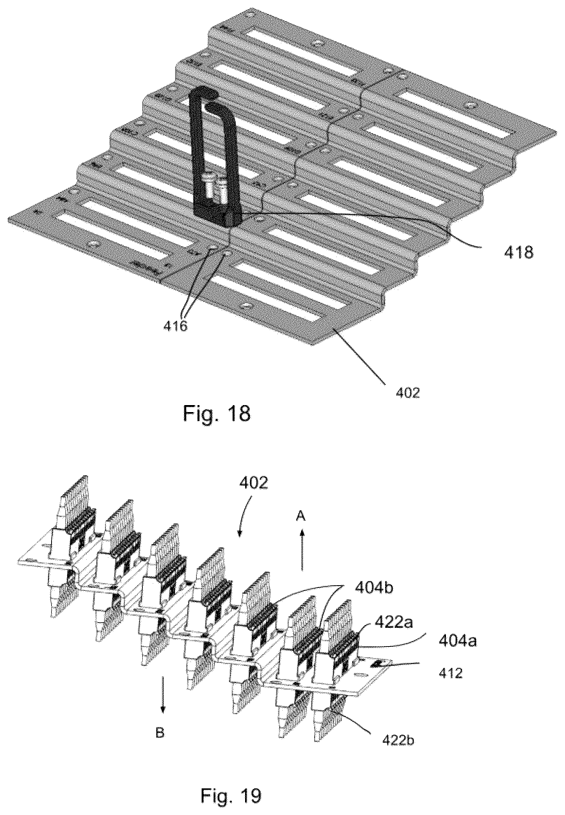

FIG. 17 and FIG. 18 are schematic representations illustrating views of multiple multi-tiered adapter frames (402) showing cable routing fingers (418) arranged in a vertically offset manner according to embodiments disclosed herein. In particular, the fiber enclosure (300) of the present invention includes a plurality of multi-tiered adapter frame (402) with a plurality of step portions (412) configured to mount single-piece integrated adapter blocks. Moreover, cable routing fingers (418) are provided on each step portion (412) to guide and secure optical fibers while maintaining proper bend radius control. Further, the cable routing fingers (418) ensure that the optical fibers are routed in an organized manner, reducing the risk of tangling and damage. The proper bend radius control provided by the cable routing fingers (418) minimizes signal loss and distortion, ensuring that the optical network operates at peak performance. The vertically offset arrangement of the cable routing fingers (418) ensures that the optical fibers are routed in a clear and unobstructed path, making it easy for technicians to perform maintenance and upgrades.

In accordance with an embodiment of the present invention, the cable routing fingers (418) are configured for removable attachment to the multi-tiered adapter frames (402). Specifically, each step portion (412) of the multi-tiered adapter frame (402) includes at least one attachment feature (416) as shown in FIG. 16, such as a receiving aperture or a threaded port. Moreover, each cable routing finger (418) has a base from which two parallel, vertical fingers extend, defining a channel for guiding optical fibers. The base of the routing finger (418) is provided with two distinct mounting apertures. Further, this specific two-aperture configuration enables the secure mounting of the cable routing fingers (418) while simultaneously ensuring the precise interlocking of adjacent adapter frames (402) within the fiber enclosure (300).

A first aperture of the cable routing finger (418) base is sized and configured to mate with an attachment feature (416) located on a step portion (412) of a first adapter frame (402). A second aperture of the routing finger (418) base is sized and configured to mate with an attachment feature (416) located on an adjacent step portion (412) of a second, adjacently arranged adapter frame (402). Further, the routing fingers (418) are removably secured to the adapter frame step portions (412) using fastening means, such as screws or other suitable mechanical fasteners (as shown in FIG. 18). This arrangement provides a dedicated routing path for the optical fibers while establishing a secure mechanical link between adjacent frames (402). The removable nature of the routing fingers (418) permits technicians to easily customize the routing configuration and simplifies maintenance procedures.

In accordance with an embodiment of the present invention, each cable routing finger (418) manages only the patch cables or fibers connected to the adapter block on the corresponding step portion (412). These cable routing fingers (418) act as localized anchor points, preventing slack or tension from building up along fiber paths. If a patch cable is accidentally pulled, strain is absorbed by the nearest finger, protecting the connection point at the adapter block. The localized management reduces cable entanglement and simplifies the process of tracing, adding, or removing a specific patch cable without disrupting connections on adjacent tiers. The cable routing fingers (418) prevent fibers from being pushed, pinched, or inadvertently bent into a tight radius during the installation of subsequent cables or the closing of an enclosure cover. The localized anchor points provided by the cable routing fingers ensure that the optical fibers are routed in an organized manner, reducing the risk of tangling and damage. The simplified cable management provided by the cable routing fingers makes it easier for technicians to perform maintenance and upgrades.

In accordance with an embodiment of the present invention, the combination of the multiple multi-tiered adapter frames (402) and vertically offset cable routing fingers (418) creates clear, straight pathways for cables to travel between different levels of the frame without running into or tangling with cables from other levels. This organized routing keeps the entire system organized, prevents cable congestion, and enables technicians to work inside the enclosure without accidentally disconnecting active connections. The clear, straight pathways provided by the combination of the multi-tiered adapter frames and vertically offset cable routing fingers ensure that the optical fibers are routed in a manner that minimizes signal loss and distortion, maintaining the integrity of the data being transmitted.

FIG. 19 is a schematic representation illustrating a side view of a multi-tiered adapter frame (402) with single-piece integrated adapter blocks (404) mounted on step portions according to embodiments disclosed herein. In particular, the multi-tiered adapter frame (402) provides a structured platform for connecting individual optical fibers from feeder fanout unit (310) and distribution fanout unit (312) units to corresponding adapter ports of the single-piece integrated adapter block (404) while enabling connection of splitter cassettes (408) for signal distribution (as shown in FIG. 1 and FIG. 2). Further, the structured platform provided by the multi-tiered adapter frame (402) ensures that the optical fibers are routed in an organized manner, reducing the risk of tangling and damage.

In accordance with an embodiment of the present invention, plurality of step portions (412) arranged in a stair-like configuration is included in the multi-tiered adapter frame (402). In particular, each step portion (412) supports at least a single-piece integrated adapter block (404) mounted perpendicularly to the step surfaces. Moreover, dual-port sub adapters (422) are included in the single-piece integrated adapter blocks (404), each sub adapter having a second adapter port (422b) facing toward a base (302) and a first adapter port (422a) facing toward a cover (314) or front access direction (A). Further, the stair-like configuration of the step portions ensures that the optical fibers are routed in a clear and unobstructed path, reducing the risk of tangling and damage. The perpendicular mounting of the adapter blocks maximizes the use of vertical space within the fiber enclosure, allowing for a high-density configuration that can accommodate a large number of connections. The dual-port sub adapters enable use of space while providing robust and reliable connections.

In accordance with an embodiment of the present invention, adapter ports (422b) of the feeder adapter block (404a) facing towards the base are configured to mate with fibers from feeder input cable. Individual fibers with connectors extending from feeder fanout units (310) are routed towards the adapter ports (422b) of the feeder adapter block (404a). In particular, mounted on the base (302), the feeder fanout units (310) are positioned substantially beneath the multi-tiered adapter frame (404) to minimize fiber routing distance and maintain proper bend radius control. Moreover, the adapter ports (422b) of the distribution adapter block (404b) are configured to mate with individual fibers with connectors extending from distribution fanout units (312). Further, the distribution fanout units (312) are also mounted on the base (302) beneath corresponding adapter ports (422b) of the distribution adapter blocks (404b), enabling fiber management and segregated routing between feeder and distribution fiber paths. Furthermore, the minimized fiber routing distance and proper bend radius control provided by the positioning of the feeder and distribution fanout units ensure that the optical signals are transmitted with minimal loss and distortion, maintaining the integrity of the data being transmitted.

In accordance with an embodiment of the present invention, the fiber enclosure of the current invention is configured to manage fiber slack precisely to ensure optimal performance and serviceability. In particular, the fiber enclosure (300) is configured to manage fiber slack precisely by providing optimized positioning of the fanout units (310, 312) relative to the multi-tiered adapter frame (402). All fanout units are mounted on the base (302) and disposed substantially beneath the adapter frame (402), which maintains a controlled fiber path and facilitates effective utilization of space.

In accordance with an embodiment of the present invention, the length of individual optical fibers extending from the feeder fanout unit (310) to the mated feeder adapter ports is maintained within a range of 260 mm to 470 mm. This wide range is determined for different possible structural embodiments:
In accordance with an embodiment of the present invention, a single feeder fanout unit (310) is configured to serve multiple adjacent adapter frames (402). In this scenario, the maximum length, for example, up to 470 mm is required to accommodate the path distance to the furthest adapter ports while still maintaining the minimum required fiber length for maintenance and re-splicing operations.

In accordance with an embodiment of the present invention, a feeder fanout unit (310) is dedicated to a single adapter frame and is mounted substantially beneath the corresponding adapter frame. In this arrangement, the fiber length is maintained, for example, closer to the 260 mm minimum, ensuring the most efficient space utilization by eliminating excess slack while still providing the necessary fiber length for maintenance purposes.

In accordance with an embodiment of the present invention, the length of fibers mated with the distribution adapter ports is maintained within a range of 260 mm to 280 mm. Further, short constrained length is maintained because a distribution fanout unit (312) is dedicated to each corresponding adapter frame (402) and is mounted substantially beneath it. This optimized, direct path provides the minimal total length required for maintenance slack without introducing excess slack within the fiber enclosure (300).

In accordance with an embodiment of the present invention, the stair-shaped design of the multi-tiered adapter frame (402) ensures clear finger access to every individual adapter port (422). Sufficient clearance for technicians to easily reach and manage each connector individually is created by the vertical offset between adjacent step portions (412). Operational and economic advantages are provided by the use of standard separate connectors. Technicians can independently service individual connections without disturbing adjacent active connections, ensuring maximum network uptime during maintenance operations. The clear finger access provided by the stair-shaped design makes it easy for technicians to perform maintenance and upgrades. The use of standard separate connectors reduces the cost and complexity of the optical network, making it more affordable and easier to manage. The ability to independently service individual connections without disturbing adjacent active connections ensures that the optical network remains operational during maintenance, minimizing downtime and disruption.

In further embodiment of the present invention, inputs of a plurality of splitter cassettes (408) are configured to mate with first adapter ports ports (422a) corresponding to the second adapter ports (422b) receiving fibers from feeder input cable. In particular, optical signals from feeder fanout units (310) pass through the sub adapters (422) of the feeder adapter block (404a) and connect to splitter inputs, enabling signal division for distribution network applications. Moreover, adapter ports (422a) of the distribution adapter block (404b) are used for connecting the output of the splitter cassettes (408). Further, the connection of splitter modules enables signal distribution, making it easier to manage and scale the optical network.

In accordance with an embodiment of the present invention, various splitter configurations, including 1×8, 1×16, 1×32, and 1×64 splitters, are enabled by the arrangement to divide a single input signal into multiple output fibers. The divided optical signals pass through the single-piece integrated adapter blocks (404) and connect to distribution fanout units (312), routing the signals to distribution network endpoints.

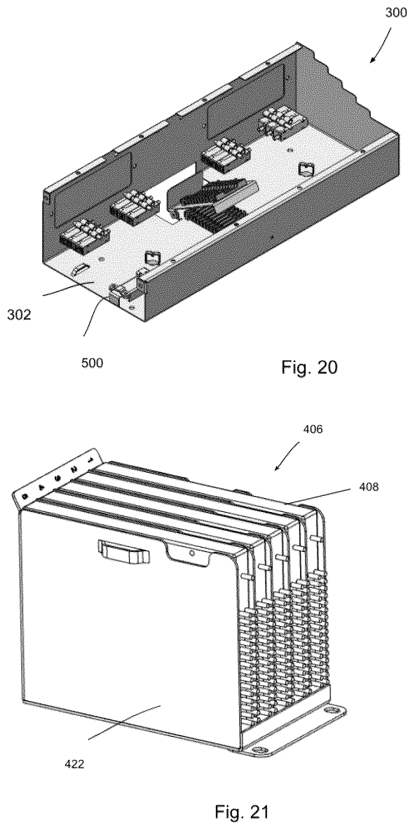

FIG. 20 is a schematic representation illustrating a perspective view of a fiber enclosure base (302) with a cable clamp (500) according to embodiments disclosed herein. In particular, the fiber enclosure's base (302) provides a mounting platform for fanout units, splicing regions, and cable management components. Moreover, the cable clamp allows to receive and secure flat input cables entering the fiber enclosure (300). Further, field-splicing capability for distribution input cables is provided by the enclosure design, allowing end-users to utilize distribution cables with variable fiber counts based on specific application requirements. Constraints of purchasing and installing cables with fixed pre-set fiber counts are eliminated by the inclusion of splice holder plates (318).

In accordance with an embodiment of the present invention, the field-splicing flexibility complements the high-density advantage of the multi-tiered adapter frame, ensuring the high-density enclosure is not bottlenecked by inflexible cable management. A high-density, high-flexibility solution is provided by the design, allowing the distribution layer to be customized post-installation, offering advantages over rigid factory-terminated systems.

FIG. 21 is a schematic representation illustrating a perspective view of a splitter bulkhead unit (406) according to embodiments disclosed herein. In particular, the splitter bulkhead unit (406) includes a multitude of splitter cassettes (408) arranged in a frame (422) in a stacked configuration. Moreover, splitter cassettes (408) are configured to house and manage optical splitters for dividing optical signals. Each splitter cassette is equipped with multiple input and output ports, allowing for signal distribution to various endpoints.

Further, the splitter cassettes (408) are mounted inside the splitter bulkhead unit (406) such that the input and output ports of the splitter cassettes (408) lie horizontally. The splitter bulkhead unit (406) is portable and mountable within a fiber enclosure. It is also demountable from the fiber enclosure for maintenance and reconfiguration.

Furthermore, the splitter cassettes (408) are mounted slidably inside the frame (422) for mounting splitter cassettes (408). This slidable mounting allows individual splitter cassettes to be inserted and removed from the frame for mounting splitter cassettes (408). The frame (422) for mounting splitter cassettes (408) forms part of the splitter bulkhead unit (406) and provides structural support for the multitude of splitter cassettes (408). The sliding mechanism is designed with smooth, low-friction rails to ensure easy movement and precise alignment of the cassettes.

In accordance with an embodiment of the present invention, the splitter bulkhead unit (406) formed by the plurality of splitter cassettes (408) mounted in the frame (422) is portable and can be mounted or demounted from the fiber enclosure as a single assembly.

In accordance with an embodiment of the present invention, the fiber enclosure (300) is configured to receive and manage input cables of differing fiber densities. Particularly, the enclosure is configured to receive at least one first input cable of a relatively lower fiber count and at least one second input cable of a higher fiber count.

In accordance with an embodiment of the present invention, the ratio of the fiber count between the first input cable and the second input cable falls within a range of 1:2 to 1:64 (preferably 1:4 to 1:32). This broad ratio enables the enclosure to accommodate cables with significant disparity in fiber density, thereby enhancing its versatility. The ability to manage such variation is important, as the higher-density cables required by large distribution systems impose increased demands on internal routing, bend radius control, and fiber organization. This ratio allows for the seamless integration of both feeder and distribution cable types within the same enclosure, without compromising accessibility, organization, or bend radius compliance. For example, the enclosure may be used for a 12-fiber cable (First Input Cable, lower density) and a 144-fiber cable (Second Input Cable, higher density), corresponding to a fiber count ratio of 1:12. In another example, the enclosure may be used for a 12-fiber cable (feeder cable—lower density) and 288-fiber (distribution cable—higher density) and corresponding to a fiber count ratio of 1:24. In another example, the enclosure may be used for a 12-fiber cable (feeder cable—lower density) and 576-fiber (distribution cable—higher density) and corresponding to a fiber count ratio of 1:48. By supporting such a wide range of cable types, the enclosure provides a flexible and scalable solution for diverse deployment scenarios.

In accordance with an embodiment of the present invention, the fiber enclosure (300) includes one or more splitter cassettes (408) to receive an input from the single-piece integrated adapter block (404) associated with the adapter frame (402). The splitter cassette (408) is designed to house and manage optical splitters (not shown). These optical splitters are used to divide a single fiber input into multiple outputs for signal distribution. The one or more splitter cassettes (408) can be configured for a broad range of split ratios, for example, but not limited to 1×8 splitter, 1×16 splitter, 1×32 splitter, or 1×64 splitter.

In accordance with an embodiment of the present invention, a fiber enclosure has a multi-tiered adapter frame (402) removably mounted within a housing, the frame defining a stair arrangement with a plurality of horizontally-extending step portions (412) separated by riser portions (430), wherein each step portion lies in a plane vertically offset from adjacent step portions by 11.6 mm to 12.5 mm, and each step portion has a depth of 15 mm to 26.5 mm, said dimensional constraints structurally enforcing a minimum optical fiber bend radius of 5 mm or 7.5 mm (or 5 mm) while enabling unobstructed front access to all adapter ports (422a) mounted thereon without requiring cassettes or splice trays.

In accordance with an embodiment of the present invention, a fiber enclosure has a plurality of single-piece integrated adapter blocks (404) each integrally molded with 8 to 12 sub-adapters (422), removably mounted via snap-fit mechanisms directly onto step portions (412) of a multi-tiered adapter frame (402) without secondary fixtures, each sub-adapter having a first port (422a) facing a common front access direction (A) and a second port (422b) facing a base (302) of the enclosure, thereby enabling tool-free block replacement and vertical segregation of feeder and distribution fiber routing paths.

Further, a fiber enclosure has a breakout assembly (306) coupled to an input port (308), the assembly having a housing with a single input opening (804) receiving an intermittently bonded ribbon (IBR) bundle (204) and a plurality of staggered through holes (806) each outputting a bond-preserved IBR bundle segment (206) into a furcation tube, wherein the staggered arrangement and 150-250 μm pitch preservation at bonded regions enable non-disruptive mass fusion splicing at 250 μm pitch without damaging intermittent bonds or requiring splice trays.

In accordance with an embodiment of the present invention, a fiber enclosure has a multi-tiered adapter frame (402) having attachment features (416) on each step portion (412), with removable cable routing fingers (418) attached thereto, wherein fingers on adjacent step portions are vertically offset to form non-overlapping, layered routing channels that structurally enforce a 5 mm or 7.5 mm minimum bend radius, prevent fiber crossover, and enable tool-free frame installation and segregated routing of feeder and distribution fibers.

In accordance with an embodiment of the present invention, a fiber enclosure has at least one feeder fanout unit (310) and a plurality of distribution fanout units (312) mounted on a base (302) directly beneath a multi-tiered adapter frame (402). Further, feeder fiber paths from the feeder fanout unit to feeder adapter ports (422b) are constrained to 260-470 mm and distribution fiber paths to distribution adapter ports (422 b) are constrained to 260-280 mm, said length constraints eliminating excess slack while ensuring sufficient service loop for re-termination and bend radius compliance.

In accordance with an embodiment of the present invention, a fiber enclosure supporting a feeder-to-distribution fiber count ratio of 1:2 to 1:64 (preferably 1:4 to 1:32) within a single compact unit is provided, It has a multi-tiered adapter frame (402) with tier-specific single-piece integrated adapter blocks (404a, 404b), wherein feeder adapter blocks (404a) are positioned on wider end steps (412₁, 412₂) and distribution adapter blocks (404b) substantially outnumber feeder blocks, enabling extreme scalability and high port density without increasing enclosure footprint or requiring cassettes.

Further, a fiber enclosure has a splicing region (600) with a plurality of splice holder plates (318) pivotably connected in a vertical stack. Each plate configured to hold multiple mass fusion splice holders for 4N fibers (N=1-10), wherein the pivotable stacking enables full accessibility to any splice without enclosure disassembly or tray removal, thereby eliminating traditional splice trays while supporting high-density mass fusion splicing in a dedicated, compact region.

In accordance with an embodiment of the present invention, the fiber enclosure solves the long-standing technical conflict in high-density FTTH deployments between achieving extreme port density, maintaining strict bend radius compliance (5 mm or 7.5 mm or 5 mm), and ensuring unobstructed technician access—without reliance on conventional cassettes or splice trays.

In accordance with an embodiment of the present invention, the enclosure has a multi-tiered adapter frame (402) having a stair arrangement of horizontally-extending step portions (412) separated by vertically-extending riser portions (430). In particular, all adapter ports (422a) are uniformly oriented to face a common front access direction (A) through mounting between 80°-100° (preferably perpendicular). Further, three-dimensional structure resolves the density-access-bend radius triad by vertically staggering adapter mounting planes to eliminate visual and physical port obstruction, leveraging riser geometry and mounting angle to enforce bend radius structurally, and enabling direct front access using standard connectors without cassettes, in contrast to prior art that teaches planar or cassette-confined solutions.

In accordance with an embodiment of the present invention, the multi-tiered adapter frame (402) defines a stair arrangement wherein the vertical offset between adjacent horizontally-extending step portions (412) is maintained in the range of 11.6 mm to 12.5 mm and the depth of each step portion (412) is maintained in the range of 15 mm to 26.5 mm. Further, interdependent dimensional constraints being specifically configured such that, when optical fiber adapters (404) are mounted at an angle of 45° to 135° (or 80° to 100°) or on a curved surface relative to the step portion, a minimum optical fiber bend radius of 5 mm or 7.5 mm (or 5 mm) is structurally enforced along the riser portions (430) while simultaneously ensuring unobstructed frontal finger access to every adapter port (422a) from a common front access direction (A), thereby eliminating the need for cassettes or splice trays in high-density environments.

In accordance with an embodiment of the present invention, the fiber enclosure (300) where all optical fiber adapter ports (422a) are oriented to face a common front access direction (A) through mounting of the adapters (404) on the step portions (412) of the multi-tiered adapter frame (402) at an angle selected from 45° to 135° (or 80° to 100°) relative to the plane of the respective step portion or via a curved mounting surface contoured along the transition between the step portion (412) and riser portion (430). Such angled or curved mounting configuration, in combination with the vertical offset between steps, ensures full frontal accessibility and compliance with a 5 mm or 7.5 mm (or 5 mm) minimum bend radius optical fibers without requiring removable cassettes or individual adapter alignment fixtures.

In accordance with an embodiment of the present invention, a fiber enclosure (300) has the multi-tiered adapter frame (402) that is configured as a cassette-free, three-dimensional stair structure with a plurality of step portions (412) each supporting a plurality of optical fiber adapters (404) in a staggered vertical and horizontal arrangement. Further, the frame is removably mounted within the housing such that all adapter ports (422a) face a common front access direction (A). The absence of splice trays or cassettes is enabled by direct routing of individual optical fibers from base-mounted fanout units (310, 312) to rear-facing adapter ports (422b) with structurally enforced bend radius control via the stair geometry.

In accordance with an embodiment of the present invention, the multi-tiered adapter frame (402) has a first step portion (412₁) and a last step portion (4122) has a width greater than that of intermediate step portions (412). Moreover, the wider end steps incorporate integrally formed mounting features (414) configured for direct, tool-assisted removable attachment of the entire frame to the base (302) or sidewalls (304) of the fiber enclosure (300). Further, the increased width of at least the first step portion (412₁) further enables side-by-side mounting of at least two optical fiber adapters (404), one designated as a feeder adapter block (404a), thereby maximizes input capacity at frame extremities and eliminating the need for separate mounting brackets or intermediate support structures.

In accordance with an embodiment of the present invention, the fiber enclosure (300) is configured such that feeder optical fibers from a feeder fanout unit (310) are routed exclusively to second adapter ports (422b) of one or more feeder adapter blocks (404a) mounted on lower or end-positioned step portions (412₁, 412₂) of the multi-tiered adapter frame (402), while distribution optical fibers from distribution fanout units (312) are routed to second adapter ports (422b) of distribution adapter blocks (404b) mounted on higher or intermediate step portions (412), the vertical offset between step portions (412) creating physically segregated, non-overlapping routing paths that prevent fiber crossover and microbending, thereby supporting feeder-to-distribution ratios of 1:2 to 1:64 (preferably 1:4 to 1:32) within a single compact unit without cassettes.

In accordance with an embodiment of the present invention, the multi-tiered adapter frame (402) has riser portions (430) interconnecting adjacent step portions (412), each riser portion being contoured with a radius of curvature of at least 8 mm or inclined at an angle of 5° to 60° relative to the step portion, in functional cooperation with a step depth of 15 mm to 26.5 mm, such that optical fibers routed from a second adapter port (422b) on one tier to a fanout unit (310, 312) beneath the frame are structurally constrained to a bend radius of not less than 5 mm or 7.5 mm, said geometric enforcement being independent of fiber type and eliminating the need for additional bend-limiting tubes or trays in high-density configurations.

In accordance with an embodiment of the present invention, a fiber enclosure (300) has the multi-tiered adapter frame (402) is configured such that every first adapter port (422a) of every sub-adapter (422) within every optical fiber adapter (404) mounted on any step portion (412) is oriented to face a single common front access direction (A) parallel to the plane of the enclosure cover (314), said uniform frontal orientation being achieved through a combination of the stair-like vertical staggering of step portions (412) and the mounting of adapters (404) at a defined angle or on a curved surface relative to each step portion, thereby enabling direct technician access to all ports without disassembly, reorientation, or removal of any frame component, even at port densities exceeding 6 ports per 100 cm².

Advantageously, the present invention is designed to reliably manage the high fiber density resulting from the 1:2 to 1:64 (preferably 1:4 to 1:32) input cable fiber count ratio. In conventional fiber enclosures, managing the output fibers from multiple high-split-ratio cassettes (e.g., 1:64) leads to immediate fiber tangling, obstruction of ports, and severe bending stress, making the enclosures unmanageable.

The ability to support this wide range is primarily enabled by following (1) Use of multi-tiered adapter frame: the stepped/stair-like geometry of the multi-tiered adapter frame (402) arranges the multiple adapter blocks (which hold the fiber ports) in a vertically offset and staggered manner. This physical separation prevents the high-count output fibers from overlapping and blocking adjacent ports, ensuring that every single port is easily accessible by a technician, even when the Second Input Cable is fully loaded at the 1×64 density extreme. (2) Bend Radius Control: Each stair step is equipped with vertically offset cable routing fingers (418). These fingers are positioned immediately adjacent to the output ports to capture and guide every fiber. This dedicated, immediate guidance prevents the fibers from being bent below the minimum bend radius required for the fibers, thereby safeguarding signal integrity. (3) Use of G.657.A2 fiber type for the input cable is critical as it offers a significantly reduced minimum bend radius requirement of 5 mm or 7.5 mm (or 5 mm). This is a major advantage compared to the G.652.D fiber type, which typically requires a 30 mm minimum bend radius. This tighter bend capability is essential for managing high fiber count input cables within compact enclosures. It allows technicians to route and organize the dense cable bundle efficiently without exceeding the critical bend radius limits, thereby preventing signal attenuation and ensuring the long-term optical performance and reliability of all connections.

In accordance with an embodiment of the present invention, split ratios below the minimum (1:2) are not relevant for splitting applications. However, for direct connection applications, a fiber of the feeder cable can be coupled to a fiber of the distribution cable using a patch cable, bypassing the splitter cassette entirely. Ratios exceeding the maximum preferred range (1:128) are not preferred in this present invention. Such a high ratio necessitates a splitter (e.g., 1×128) which would incur excessive insertion loss, making it difficult to maintain the required optical power levels at the end user without introducing external amplification, thereby diminishing reliability. Therefore, the ratio of 1×64 is the practical upper limit for reliable passive splitting in the context of the present invention.

In accordance with an embodiment of the present invention, an optimized high-density fiber deployments with a frame having a stair-step design is provided. It provides front access to all ports while eliminating push-pull connectors. This space-efficient architecture supports 1:64 feeder: distribution ratios in compact footprints. This single-piece adapter blocks integrate 8-12 sub-adapters with snap-fit mounting for rapid field replacement, with ports oriented toward both the base (internal fibers) and cover (splitter/patch access). The range of 8 to 12 sub-adapters per block allows a balance between high port density and manageable handling during installation or servicing. For example, instead of installing 12 individual adapters one by one, a technician can simply snap a 12-port adapter block into position on a step, significantly reducing installation time and the potential for misalignment or connection errors. For example, if mounting an individual adapter to the adapter frame requires at least 2 seconds, installing 12 individual adapters would take at least 24 seconds.

A technician can instead simply snap the 12-port single-piece adapter block into position on the multi-tiered adapter frame (402), saving those 24 seconds and significantly reducing overall installation time. Furthermore, the single-piece integrated adapter block offers significantly greater structural rigidity compared to a row of small, interconnected adapters. This makes the adapter block more resistant to physical stress, vibration, and accidental impact during installation or maintenance. The adapter block allows for the tightest possible port spacing because the entire housing structure is accounted for in one mold design. This maximizes the number of ports that can fit onto the specific dimensions of your inventive multi-tiered step portion. By eliminating individual housing walls, retention clips/tabs, the single-piece integrated adapter block minimizes the non-functional space between ports. This results in a tighter physical width, maximizing the utilization of the available step width 25.7 mm (for example) and achieving a port density increase of approximately 10% to 15% compared to using individual adapters. Mounting more than 12 adapters in a single-piece adapter block primarily leads to increased size and handling difficulty, making the single-piece adapter block heavy and bulky, which complicates the mounting of the adapter block onto the adapter frame, and precise alignment during installation and servicing. Furthermore, a very long block is more susceptible to warping or breakage due to physical stress across its length. Using fewer than 8 sub-adapters per block necessitates a high number of adapter blocks to manage a high fiber count. This increased count of individual blocks directly results in a proportional increase in the overall enclosure size required to house all the necessary step portions.

In accordance with an embodiment of the present invention, IBR-optimized breakout assemblies maintain bonded fiber pitch (150-250 μm) for seamless mass splicing, while integrated routing fingers on each step prevent microbending through strict bend radius control. This modular system allows effortless reconfiguration or removal of adapter blocks, and adapter frames to adapt to evolving network needs. Specifically, the unobstructed access and tool-less snap-fit mounting of the single-piece adapter blocks (404) and the overall modular architecture of the multi-tiered adapter frame (402) enable the effortless reconfiguration or removal of these components.

In accordance with an embodiment of the present invention, a high-density fiber solution delivers greater port density than traditional cassette-based systems while ensuring clear, unobstructed technician access to every port. It significantly reduces costs by eliminating splicing cassettes and utilizing standard connectors, while enabling granular fiber deployment and field-customizable scalability to match evolving network demands. Crucially, the design maintains reliability by protecting IBR cable integrity and strictly enforcing critical bend radius requirements throughout all connection points.

The fiber enclosure for receiving and managing a plurality of optical fiber cable with a high density of optical fibers. In particular, the fiber enclosure is capable of providing end users or technicians a better accessibility of adapter ports for coupling feeder and distribution fibers while managing the input cables with high density of optical fibers. Moreover, the fiber enclosure is capable of maintaining a minimum bend radius of optical fibers while managing the input cable with high density optical fibers and accessibility of the adapter ports. Further, the fiber enclosure is capable of receiving and managing input cables with Intermittently Bonded Ribbon (IBR) bundles without the need of large sized cassette modules or splice trays.

The technical problem of simultaneously achieving extreme port density, full front accessibility, and strict 5 mm or 7.5 mm (5 mm) bend radius compliance in compact fiber enclosures—without cassettes or splice trays—is solved by a multi-tiered adapter frame (402) defining a stair arrangement, wherein a plurality of horizontally-extending step portions (412) are separated by vertically-extending riser portions (430), each step portion lying in a plane offset from adjacent steps, and optical fiber adapters (404) are mounted thereon such that adapter ports (422a) face a common front access direction (A). This three-dimensional, cassette-free configuration structurally enforces bend radius through riser geometry and mounting angle, vertically segregates fiber paths to prevent crossover, and ensures unobstructed technician access to every port using standard connectors, thereby resolving the density-access-bend radius conflict in space-constrained FTTH deployments. Unlike the prior arts, the present configuration eliminates cassettes entirely, structurally enforces bend radius through the interdependent geometry of riser contour, step depth (15-26.5 mm), and mounting angle, and ensures unobstructed technician finger access to every adapter port (422a) using standard connectors, thereby resolving the density-access-bend radius conflict in space-constrained FTTH deployments.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

In a case that no conflict occurs, the embodiments in the present invention and the features in the embodiments may be mutually combined. The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A fiber enclosure (300) for receiving and managing a plurality of optical fibers, comprising:
a housing defining an interior volume, wherein the housing comprises a base (302), a plurality of sidewalls (304) extending from the base (302), and a cover (314) coupled to the base (302);
a plurality of input ports (308) provided on at least one of the sidewalls (304), wherein the plurality of input ports (308) are configured to receive a plurality of input cables (202) having the plurality of optical fibers arranged in a plurality of optical fiber bundles, wherein the plurality of input cables (202) is made of optical fibers configured to bend 5 mm or 7.5 mm radius optical fibers compliant with ITU-T G.657.
a plurality of fanout units (310, 312) disposed within the housing, wherein each of the fanout units (310, 312) is configured to receive at least one of the plurality of optical fiber bundles; and
a multi-tiered adapter frame (402) defining a stair arrangement removably mounted within the housing, wherein the multi-tiered adapter frame (402) comprises:
a plurality of horizontally-extending step portions (412) separated by vertically-extending riser portions (430), wherein each of the horizontally-extending step portions (412) lie in a plane offset from adjacent horizontally-extending step portions (412); and
a plurality of optical fiber adapters (404) mounted on the plurality of horizontally-extending step portions (412), wherein each optical fiber adapter (404) is oriented such that a plurality of adapter ports (422a) fact a common front access direction (A), the mounting angle of each adapter port (422a) relative to its step portion (412) is angled between 80° to 100° and the plurality of horizontally-extending step portions (412) are curved (a non-linear surface) or angled between 45° and 135°.

2. The fiber enclosure (300) as claimed in claim 1, wherein the stair arrangement defines a vertical offset between adjacent step portions (412) in a range of 11 mm to 12.5 mm, and a step depth in a range of 15 mm to 26.5 mm maintaining minimum fiber bend radius and front access.

3. The fiber enclosure (300) as claimed in claim 1, wherein the plurality of input cables (202) comprises at least one first input cable and at least one second input cable, wherein the second input cable is a higher-density fiber cable than the first input cable, and wherein a ratio of the fiber count of the first input cable to the second input cable is in a range of 1:2 to 1:64 (optionally 1:4 to 1:32).

4. The fiber enclosure (300) as claimed in claim 3, wherein the at least one first input cable is a feeder cable and the at least one second input cable is a distribution cable

5. The fiber enclosure of claim 1, wherein each optical fiber adapter (404) comprises a single-piece adapter block removably mounted on a step portion (412) and including 8 to 12 integrally formed sub-adapters (422).

6. The fiber enclosure (300) as claimed in claim 5, wherein the plurality of single-piece integrated adapter blocks (404) mounted on the step portions (412) of the adapter frame (402) defines feeder adapter block (404a) and distribution adapter block (404b), wherein a number of the distribution adapter blocks (404b) is more than number of the feeder adapter block (404a).

7. The fiber enclosure (300) as claimed in claim 6, wherein each single-piece integrated adapter block (404) include a plurality of sub adapters (422), wherein each of the sub adapters (422) have a second adapter port (422b) facing toward the base (302) and a first adapter port (422a) facing toward the cover (314) of the fiber enclosure (300), wherein the second adapter port (422b) is configured to mate with the fibers of the plurality of input cables (202), and wherein the multi-tiered adapter frame (402) provides a vertical offset between adjacent single-piece integrated adapter blocks (404) to facilitate segregated routing of the fibers.

8. The fiber enclosure (300) as claimed in claim 1, wherein at least two step portions (412) of the adapter frame (402) have a width greater than a width of remaining step portions (412), and wherein the at least two step portions each comprise at least one mounting feature (414) configured to removably mount the adapter frame (402) within the fiber enclosure (300).

9. The fiber enclosure (300) as claimed in claim 8, wherein one of the first and last step portions (4121, 412n) of the adapter frame (402) comprises greater width and is configured to mount at least two single-piece integrated adapter blocks (404), one of which is a feeder adapter block (404a).

10. The fiber enclosure (300) as claimed in claim 1, comprises:
attachment features (416) provided on each of the step portions (412); and
a plurality of cable routing fingers (418) removably attached to the attachment features (416), wherein each of the cable routing fingers (418) is vertically offset from the cable routing fingers (418) provided on the adjacent step portion (412).

11. The fiber enclosure (300) as claimed in claim 1, wherein the plurality of input cables (202) comprises at least one intermittently bonded ribbon (IBR) bundle (204₁, 204₂, . . . 204ᵢ, . . . 204ₙ), wherein each IBR (208) comprises a plurality of optical fibers (210₁, 210₂, . . . 210ᵢ, . . . 210ₙ) such that adjacent optical fibers are bonded intermittently with a matrix material in a staggered bonding pattern.

12. The fiber enclosure (300) as claimed in claim 11, comprises a plurality of breakout
assemblies (306a, 306b) disposed within the fiber enclosure (300) and coupled to the plurality of input ports (308), wherein each breakout assembly (306a) comprises a housing having a first opening (804) sized and configured to receive an IBR bundle (204) from at least one of the input cables (202), and a plurality of through holes (806). Each through hole (806) is configured to output an IBR bundle segment (206) of the IBR bundle (204) housed within a plurality of furcation tubes, while preserving the intermittent bonding between the adjacent fibers

13. The fiber enclosure of claim 1, wherein the plurality of fanout units comprising at least one feeder fanout unit (310) mounted on the base beneath the adapter frame, and individual optical fibers extending from the feeder fanout unit to feeder adapter ports have lengths of 260 mm to 470 mm.

14. The fiber enclosure (300) as claimed in claim 1, wherein the plurality of fanout units (310, 312) includes a plurality of distribution fanout units (312), each distribution fanout unit (312) unit mounted on the base (302) and disposed substantially beneath the corresponding adapter frame (402), and wherein the adapter frame (402) comprises a plurality of distribution adapter ports, the arrangement being configured to maintain a length of the individual optical fibers extending from the at least one distribution fanout unit (312) and mated with distribution adapter ports of within a range of 260 mm to 280 mm.

15. The fiber enclosure (300) as claimed in claim 14, wherein each distribution fanout unit (312) comprises a housing having a plurality of ribbonized optical fibers (216) at an opening (322) of the housing and a plurality of individual fibers at a plurality of through holes (324), wherein the individual fibers at the at the plurality of through holes (324) are mated with the second adapter ports (422b) of the corresponding distribution adapter block (404b) distribution adapter ports (422b).

16. The fiber enclosure (300) as claimed in claim 1, comprises a splicing region (600), wherein the splicing region (600) includes a plurality of splice holder plates (318) pivotably connected to each other in a vertically stacked manner, wherein each splice holder plate (318) including a plurality of splice holders configured to allow mass fusion splicing.

17. An adapter frame (402) for a fiber enclosure, wherein the adapter frame (402) comprises:
a body being a multi-tiered frame defining a stair arrangement and comprises a plurality of step portions (412) separated by riser portions (430), wherein each step portion (412) lies in a plane offset vertically from adjacent step portions (412), and wherein at least two step portions of the multi-tiered frame have a width greater than a width of remaining step portions;
a plurality of adapters (404) removably mounted on each step portion (412), wherein each adapter (404) is mounted perpendicular to a surface of the step portion (412); and
a plurality of mounting features (414) provided on the at least two step portions configured to removably mount the adapter frame (402) within the fiber enclosure (300).

18. The adapter frame (402) as claimed in claim 17, wherein the step portions (402) are configured to receive and secure a plurality of single-piece integrated adapter blocks (402), each block comprising a plurality of sub adapters (422) formed in a single-piece construction.

19. The adapter frame (402) as claimed in claim 17, wherein the single-piece integrated adapter blocks are removably mounted to the step portions (412) of the adapter frame (402) using a snap-fit mechanism.

20. The adapter frame (402) as claimed in claim 17, wherein one of the first and last step portions (412₁, 412ₙ) having greater width to mount at least two single-piece integrated adapter blocks, one of which is a feeder adapter block.

21. An adapter frame (402) for a telecommunications enclosure (300), the adapter frame (402) comprises:
a body being a multi-tiered frame that defines a stair arrangement, wherein the body comprises a plurality of step portions (412) separated by riser portions (430), wherein each step portion (412) lies in a plane vertically offset from adjacent step portions (412);
a plurality of adapters (404) mounted on each step portion (412), wherein each adapter (404) is mounted perpendicular to a surface of the step portion (412); and
at least one attachment feature provided on each of the step portions (412), wherein the at least one attachment feature is configured to removably receive a cable routing finger (418), wherein each of the cable routing fingers (418) is vertically offset from the cable routing fingers provided on the adjacent step portion (412);
wherein one of the first and last step portions (4121, 412n) has greater width to mount at least two single-piece integrated adapter blocks.
